(19) United States
(12) Patent Application Publication
(10) Pub. No.: US 2011/0106794 A1
(43) Pub. Date: May 5, 2011

(54) Synthesis path evaluation system and method and program thereof

(75) Inventors: Kenji Hori, Yamaguchi (JP); Toru Yamaguchi, Yamaguchi (JP)

(73) Assignee: YAMAGUCHI UNIVERSITY, Yamaguchi-shi, Yamaguchi (JP)

(21) Appl. No.: 13/000,759

(22) PCT Filed: Jun. 22, 2009
(86) PCT No.: PCT/JP2009/002841

§ 371 Date: Dec. 22, 2010

(30) Foreign Application Priority Data
Jun. 25, 2008 (JP) 2008-166649

(51) Int. Cl. G06F 17/30

(52) U.S. Cl. 707/723; 707/E17.014

(57) ABSTRACT

A synthetic route evaluation system extracts an optimal synthetic route from a plurality of synthetic routes for a target compound to be synthetically produced. The synthetic route evaluation system includes an arithmetic processing device, which is composed of a quantum chemistry calculation unit, a reaction mechanism analysis unit, and a synthetic route ranking unit, and a storage device for storing data relative to the synthetic routes.

### TECHNICAL FIELD

This invention relates to a synthetic route evaluation system for extracting an optimal synthetic route from a plurality of synthetic routes to synthetically produce a target compound, a synthetic route evaluation method thereof, and a synthetic route evaluation program thereof.

### BACKGROUND ART

To create a novel compound that is a constituent of a new medicine or the like, it is necessary to find synthetic routes used to synthetically produce the compound in a chemical plant or a laboratory. So far, a proposal for synthetic routes by use of computers has been regarded as an extremely difficult problem, and, even if the proposal can be carried out by the computers, determination of whether syntheses can be achieved by the routes proposed thereby has not been able to be made without actually performing experiments.

Roughly, the following three steps exist before synthetically producing a target compound:

(1) Step of proposing synthetic routes for the target compound,
(2) Step of selecting routes that enable synthesis from the proposed synthetic routes, and
(3) Step of performing synthesis by use of the selected synthetic routes.

These steps are repeatedly performed through a trial and error process, and an optimal synthetic route is finally selected. If such an optimal synthetic route cannot be selected, a long time will be spent to synthetically produce the target compound, or costs will be raised, or, in the worst case, the target compound will not be synthetically produced. Therefore, it is very important to select optimal routes shown at step (2) mentioned above. Herein, step (1) has been known as being able to be proposed by a cheminformatics-aided means. When new synthetic routes for a target compound are created, it is known that computers are used to analyze reaction mechanisms (see Patent Documents 1 and 2).

However, a synthetic route is formed of a process having the flow: Select an appropriate synthesis starting substance→Allow the starting substance to react appropriately→Reach a target substance. When consideration is paid to its reaction stage, several stages to tens of stages occur in most cases. For example, if ten-stage reactions are required to synthetically produce a target compound and if the number of reaction patterns at each stage is two, the number of synthetic routes is the 10th power of 2, i.e., 1024. It is step (2) where an optimal one is selected from among these synthetic routes. However, a method of performing this process with computers has not yet been invented. The reason is that whether a compound can be synthetically produced along synthetic routes has been regarded as being unable to be determined without actually performing experiments.

Therefore, under existing circumstances at the present time, step (2) is performed while relying on the knowledge and experience of a person who is called a synthetic chemist. However, it is extremely difficult to select an optimal one from the 1024 synthetic routes mentioned above even if the person is an experienced chemist.

### PRIOR ART DOCUMENTS

### Patent Documents

Patent Document 1: Japanese Published Unexamined Patent Application No. 2002-262869
Patent Document 2: Japanese Published Unexamined Patent Application No. 2004-119742

### BRIEF SUMMARY OF THE INVENTION

### Problems to be Solved by the Invention

Therefore, the present invention provides a synthetic route evaluation system that is capable of proposing synthetic routes obtained by automatically ranking and narrowing down a plurality of synthetic routes given for a target compound to be synthetically produced, provides a synthetic route evaluation method thereof, and provides a synthetic route evaluation program thereof.

### Means for Solving the Problems

To achieve the above-mentioned object, a synthetic route evaluation system which is an invention of claim 1 is characterized in that, in order to extract an optimal synthetic route from a plurality of synthetic routes for a target compound to be synthetically produced, the synthetic route evaluation system comprises an arithmetic processing means, which is composed of a quantum chemistry calculation unit, a reaction mechanism analysis unit, and a synthetic route ranking unit, and a storage means for storing data (hereinafter, referred to as synthetic route data) relative to the synthetic routes, wherein the synthetic route data is composed of structure data pairs the number of which is equal to the number of precursors from which the target compound can be synthetically produced, the structure data pairs being formed by correlating structure data relative to the target compound and structure data relative to the plurality of starting compounds with each other; wherein the quantum chemistry calculation unit executes a step of reading the synthetic route data from the storage means, performing a calculation in such a manner as to substitute the structure data relative to the starting compounds and the target compound into a structural optimization function, and obtaining structure data relative to the starting compounds structurally optimized and structure data relative to the target compound structurally optimized; and a step of performing a calculation in such a manner as to substitute the structure data relative to the starting compounds structurally optimized and the structure data relative to the target compound structurally optimized into a synthetic-route transition state search function, and obtaining data relative to the presence or absence of a transition state in the synthetic routes and structure data relative to the transition state under the condition of the presence of the transition state; wherein the reaction mechanism analysis unit executes a step of setting data relative to whether a transition state is present or absent in the synthetic routes as a key from the storage means, and, if a transition state is present, performing a calculation in such a manner as to substitute structure data relative to the transition state into an activation energy calculation function, and obtaining activation energy and/or reaction heat in the transition state; and wherein the synthetic route ranking unit executes a step of setting the activation energy and/or the reaction heat calculated while being correlated with the plurality of starting compounds as a key, and creating a data set in which the activation energy and/or the reaction heat are arranged in desired order along with the starting compounds and/or the target compound.

The invention of claim 2 is the synthetic route evaluation system according to claim 1, and is characterized in that the quantum chemistry calculation unit executes a step of performing a calculation in such a manner as to substitute the structure data relative to the transition state into the structural optimization function and obtaining structure data relative to a transition state structurally optimized, and the reaction mechanism analysis unit performs a calculation in such a manner as to substitute the structure data relative to a transition state structurally optimized into the activation energy calculation function.

The invention of claim 3 is the synthetic route evaluation system according to claim 1 or claim 2, and is characterized in that the arithmetic processing means includes a yield prediction unit, wherein the yield prediction unit executes a step of, if there is a yield prediction formula pre-stored in the storage means, reading the yield prediction formula, then performing a calculation in such a manner as to substitute the structure data pairs of the synthetic route data into the yield prediction formula, and obtaining a predicted yield of each starting compound, or executes a step of, if there is not a yield prediction formula pre-stored in the storage means, reading experimental data relative to a reaction similar to a reaction caused to synthetically produce a target compound from the starting compounds stored in the storage means, then analyzing the yield prediction formula by use of a result of the experimental data, then performing a calculation in such a manner as to substitute the structure data pairs of the synthetic route data into the analyzed yield prediction formula, and obtaining a predicted yield of the starting compound, and wherein the synthetic route ranking unit executes a step of creating a data set in which activation energy and/or reaction heat calculated in correlation with the plurality of starting compounds is arranged in desired order along with the starting compounds and/or the target compound while setting the activation energy and/or the reaction heat as a key or setting the predicted yield as a key.

The invention of claim 4 is the synthetic route evaluation system according to claim 3, and is characterized in that the arithmetic processing means includes a side reaction prediction unit, wherein the side reaction prediction unit executes a step of searching for data relative to a similar reaction pre-stored in the storage means while setting the target compound and the starting compounds as a key, and defining and constructing a reaction similar to a synthetic route relative to a combination of the target compound and the starting compounds as a side reaction, and wherein the synthetic route ranking unit executes a step of creating a data set in which activation energy and/or reaction heat calculated in correlation with the plurality of starting compounds or the predicted yield or the number of the side reactions is set as a key and is arranged in desired order along with the starting compounds and/or the target compound.

The invention of claim 5 is the synthetic route evaluation system according to claim 4, and is characterized in that the arithmetic processing means includes a side reaction prediction unit, wherein the side reaction prediction unit executes a step of searching for data relative to a similar reaction pre-stored in the storage means while setting the target compound and the starting compounds as a key, and defining and constructing a reaction similar to a synthetic route relative to a combination of the target compound and the starting compounds as a side reaction, wherein the yield prediction unit executes a step of obtaining a predicted yield with respect to the target compound and the starting compounds in the constructed side reaction, and wherein the synthetic route ranking unit executes a step of creating a data set in which activation energy and/or reaction heat calculated in correlation with the plurality of starting compounds, or the predicted yield or the number of the side reactions, or the predicted yield of the side reaction is set as a key and is arranged in desired order along with the starting compounds and/or the target compound.

The invention of claim 6 is the synthetic route evaluation system according to any one of claim 1 to claim 5, and is characterized by further comprising an output means for outputting the data set created by the synthetic route ranking unit.

The invention of claim 7 is a synthetic route evaluation method for, in order to extract an optimal synthetic route from a plurality of synthetic routes for a target compound to be synthetically produced while a computer performs each step, analyzing data (hereinafter, referred to as synthetic route data) relative to the synthetic routes, transition states halfway along the synthetic routes, and activation energy relative to the transition states and evaluating the optimal synthetic route, and the synthetic route evaluation method comprises a first quantum chemical calculation step of performing a calculation in such a manner as to substitute structure data relative to the target compound included in the synthetic route data and structure data relative to a plurality of starting compounds from which the target compound can be synthetically produced into a structure optimizing function and obtaining structure data relative to the starting compounds structurally optimized and structure data relative to the target compound structurally optimized; a second quantum chemical calculation step of performing a calculation in such a manner as to substitute the structure data relative to the starting compounds structurally optimized and the structure data relative to the target compound structurally optimized into a synthetic-route transition state search function and obtaining data relative to the presence or absence of a transition state in the synthetic routes and structure data relative to the transition state under the condition of the presence of the transition state; a reaction analysis step of setting data relative to whether a transition state is present or absent in the synthetic routes as a key, and, if a transition state is present, performing a calculation in such a manner as to substitute structure data relative to the transition state into an activation energy calculation function, and obtaining activation energy and/or reaction heat in the transition state; and a synthetic route ranking step of setting the activation energy and/or the reaction heat calculated in correlation with the plurality of starting compounds as a key and creating a data set in which the activation energy and/or the reaction heat is arranged in desired order along with the starting compounds and/or the target compound.

The invention of claim 8 is a synthetic route evaluation program for, in order to extract an optimal synthetic route from a plurality of synthetic routes for a target compound to be synthetically produced by use of a computer, analyzing data (hereinafter, referred to as synthetic route data) relative to the synthetic routes, transition states halfway along the synthetic routes, and activation energy relative to the transition states and evaluating the optimal synthetic route, and the synthetic route evaluation program allows the computer to perform a first quantum chemical calculation step of performing a calculation in such a manner as to substitute structure data relative to the target compound included in the synthetic route data and structure data relative to a plurality of starting compounds from which the target compound can be synthetically produced into a structure optimizing function and obtaining structure data relative to the precursors structurally optimized and structure data relative to the target compound structurally optimized; a second quantum chemical calculation step of performing a calculation in such a manner as to substitute the structure data relative to the starting compounds structurally optimized and the structure data relative to the target compound structurally optimized into a synthetic-route transition state search function and obtaining data relative to the presence or absence of a transition state in the synthetic routes and structure data relative to the transition state under the condition of the presence of the transition state; a reaction analysis step of setting data relative to whether a transition state is present or absent in the synthetic routes as a key, and, if a transition state is present, performing a calculation in such a manner as to substitute structure data relative to the transition state into an activation energy calculation function, and obtaining activation energy and/or reaction heat in the transition state; and a synthetic route ranking step of setting the activation energy and/or the reaction heat calculated in correlation with the plurality of starting compounds as a key and creating a data set in which the activation energy and/or the reaction heat is arranged in desired order along with the starting compounds and/or the target compound.

### Effects of the Invention

In the synthetic route evaluation system of the present invention, synthetic routes from a plurality of existing starting compounds to a target compound can be evaluated by use of a quantum chemistry calculation result or a reaction analysis result when new or already-known compounds are synthesized. Additionally, the synthetic routes can be ranked in desired order based on an evaluation thereof. Therefore, an optimal synthetic route can be extracted, and can be obtained without newly performing experiments, and a development time for synthetic routes can be remarkably shortened, and, at the same time, development cost can be reduced. Additionally, a synthetic chemist who has expert knowledge is not necessarily needed, and the number of experiments can be reduced, and an environment-friendly new compound, such as a new medicine, can be synthetically produced swiftly and safely.

Additionally, especially in the invention of claim 2, structure data relative to a transition state optimized can be used, and therefore activation energy and/or reaction heat can be calculated for the same calculation time with higher accuracy or for a shorter calculation time with the same accuracy.

Additionally, especially in the invention of claim 3, it is possible to calculate not only activation energy and/or reaction heat but also a predicted yield of each starting compound for a target compound, and therefore an optimal synthetic route can be extracted while considering many more factors.

Especially in the inventions of claim 4 and claim 5, an optimal synthetic route can be calculated while considering many more factors including a side reaction prediction.

In the inventions of claims 7 and 8, the invention of claim 1 is defined as a method invention and as a program invention performed by use of a computer, respectively, and, synthetic routes from a plurality of existing starting compounds to a target compound can be evaluated in the same way as in the synthetic route evaluation system, and, at the same time, the synthetic routes can be ranked in desired order based on an evaluation thereof. Therefore, an optimal synthetic route can be extracted, and can be obtained without newly performing experiments, and a development time for synthetic routes can be remarkably shortened, and, development cost can be reduced. Additionally, a synthetic chemist who has expert knowledge is not necessarily needed, and the number of experiments can be reduced, and an environment-friendly new compound, such as a new medicine, can be synthetically produced swiftly and safely.

### BRIEF DESCRIPTION OF THE DRAWINGS

FIG. 1 is a schematic view of a synthetic route evaluation system according to an embodiment of the present invention.

FIG. 2 is a functional schematic view of the synthetic route evaluation system according to the embodiment.

FIG. 3 is a process flowchart of the synthetic route evaluation system according to the embodiment.

FIG. 4 is a process flowchart of a synthetic route input/output function of an arithmetic processing device of the synthetic route evaluation system according to the embodiment.

FIG. 5 is a conceptual diagram of synthetic route data showing the relationship between a target compound (product) and starting compounds (reactants).

FIG. 6 is a conceptual diagram of synthetic route data in a Dieckmann condensation reaction.

FIG. 7 is a conceptual diagram of synthetic route data in a Dieckmann condensation reaction.

FIG. 8 is a conceptual diagram of the output of synthetic routes, which have been ranked, for a target compound.

FIG. 9 is a process flowchart of a reaction analysis function of the arithmetic processing device of the synthetic route evaluation system according to the embodiment.

FIG. 10 is a conceptual diagram of a calculation input file of a product obtained at a first stage of a synthetic route in the Dieckmann condensation reaction.

FIG. 11 is a three-dimensional conceptual diagram of the calculation input file of the product obtained at the first stage of the synthetic route in the Dieckmann condensation reaction.

FIG. 12 is a conceptual diagram showing an archive part of a file of quantum chemistry calculation result data of the product obtained at the first stage of the synthetic route in the Dieckmann condensation reaction.

FIG. 13 is a conceptual diagram that visualizes one of two pieces of reaction analysis data at a second stage of the synthetic route in the Dieckmann condensation reaction.

FIG. 14 is a conceptual diagram that visualizes the other one of the two pieces of reaction analysis data at the second stage of the synthetic route in the Dieckmann condensation reaction.

FIG. 15 is a process flowchart of a quantum chemistry calculation function of the arithmetic processing device of the synthetic route evaluation system according to the embodiment.

FIG. 16 is a process flowchart of a reaction yield prediction function in a yield prediction unit of the arithmetic processing device of the synthetic route evaluation system according to the embodiment.

FIG. 17 is a process flowchart of a side reaction prediction function in a side reaction prediction unit of the arithmetic processing device of the synthetic route evaluation system according to the embodiment.

FIG. 18 is a process flowchart of a synthetic route ranking function in a synthetic route ranking unit of the arithmetic processing device of the synthetic route evaluation system according to the embodiment.

FIG. 19 is a conceptual diagram showing data relative to supplementary items that are added during processing of the synthetic route ranking function in the arithmetic processing device of the synthetic route evaluation system according to the embodiment.

1 . . . Synthetic route evaluation system
2 . . . Input device
3 . . . Arithmetic processing device
4 . . . First storage device
5 . . . Second storage device
6 . . . Output device
7 . . . Quantum chemistry calculation unit
8 . . . Reaction mechanism analysis unit
9 . . . Yield prediction unit
10 . . . Side reaction prediction unit
11 . . . Synthetic route ranking unit
15 . . . Synthetic route data
15a . . . User synthetic route data
15b . . . SRDS synthetic route data
16 . . . Reaction analysis result data
17 . . . Predicted yield data
18 . . . Predicted side reaction data
19 . . . Supplementary item data
20 . . . Route ranking data
20a . . . Already-ranked synthetic route group
25 . . . Experimental data
25a . . . Outside experimental data
26 . . . Quantum chemistry calculation result data
26a . . . Quantum chemistry calculation result data
27 . . . Yield prediction formula data
28 . . . Calculation input data
29 . . . Reactant
30 . . . Reactant
31 . . . Product
32 . . . Reactant
33 . . . Calculation input data structure
34 . . . Nitrogen atom
35 . . . Oxygen atom
36 . . . Carbon atom
37 . . . Hydrogen atom
41 . . . Data calculation result file structure
42 . . . First transition state
42a . . . Activation energy
43 . . . Second transition state
43a . . . Activation energy
44 . . . Third transition state
44a . . . Activation energy
45 . . . First transition state
45a . . . Activation energy
46 . . . Second transition state
46a . . . Activation energy
47 . . . Third transition state
47a . . . Activation energy
48 . . . Fourth transition state
48a . . . Activation energy

### BEST MODE FOR CARRYING OUT THE INVENTION

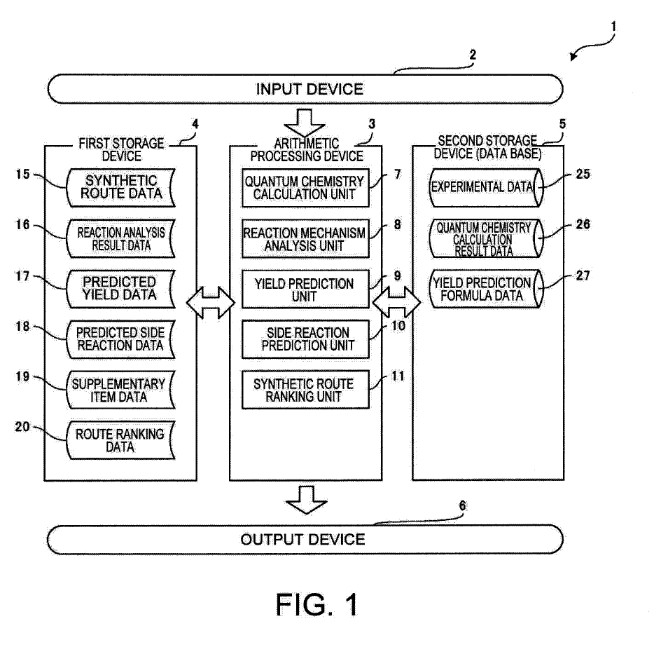

With reference to FIG. 1 to FIG. 19, a description will be hereinafter given of a synthetic route evaluation system, a synthetic route evaluation method, and a synthetic route evaluation program according to a most preferred embodiment of the present invention.

FIG. 1 is a schematic view of the synthetic route evaluation system according to the embodiment. In FIG. 1, the synthetic route evaluation system 1 according to the embodiment is composed of five constituents, i.e., an input device 2, an arithmetic processing device 3, a first storage device 4, a second storage device (data base) 5, and an output device 6.

First, various pieces of data are input from the input device 2, are then processed in the arithmetic processing device 3, and are stored in the first storage device 4 serving as a main storage device that is capable of temporarily storing data and in the second storage device (data base) 5 that is capable of persistently storing data. Data stored therein are also read and processed by each constituent of the arithmetic processing device 3. Data obtained by being processed by the arithmetic processing device 3 are displayed by the output device 6 or is output to an external device.

Specifically, the input device 2 is any one of or any combination of a plurality of kinds of devices, i.e., a keyboard, a mouse, a pen tablet, an optical or magnetic reader, and a receiver that receives data via a communication line from, for example, an analyzer or a measuring device such as a computer.

The arithmetic processing device 3 is composed of a quantum chemistry calculation unit 7, a reaction mechanism analysis unit 8, a yield prediction unit 9, a side reaction prediction unit 10, and a synthetic route ranking unit 11.

The first storage device 4 is a storage device that stores synthetic route data 15, reaction analysis result data 16, predicted yield data 17, predicted side reaction data 18, supplementary item data 19, and route ranking data 20, whereas the second storage device 5 is a storage device that stores experimental data 25, quantum chemistry calculation result data 26, and yield prediction formula data 27.

Specifically, a CRT, liquid crystal, plasma, or organic EL, etc., display device, a display device of, for example, a printer, or a signal sending device, such as a transmitter, for sending signals toward an external device can be used as the output device 6.

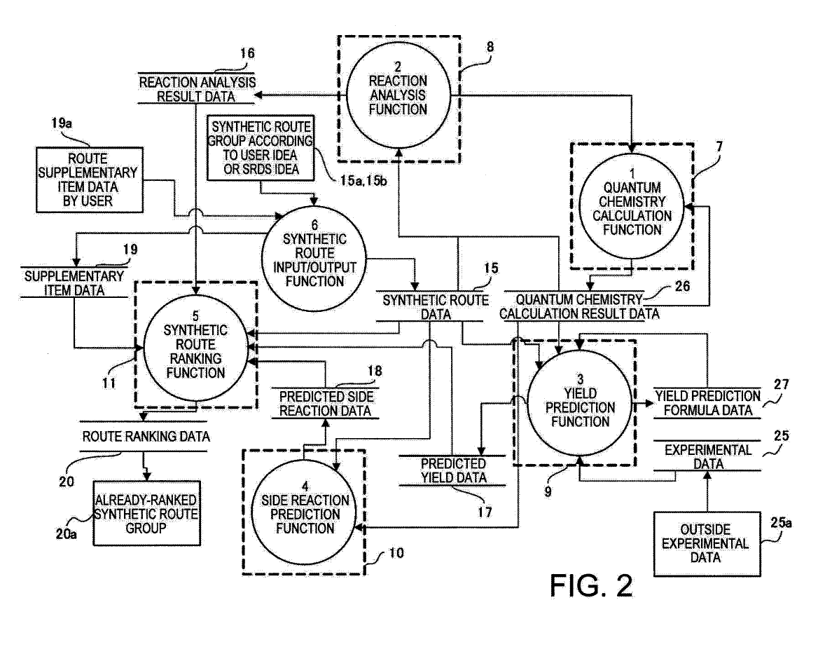

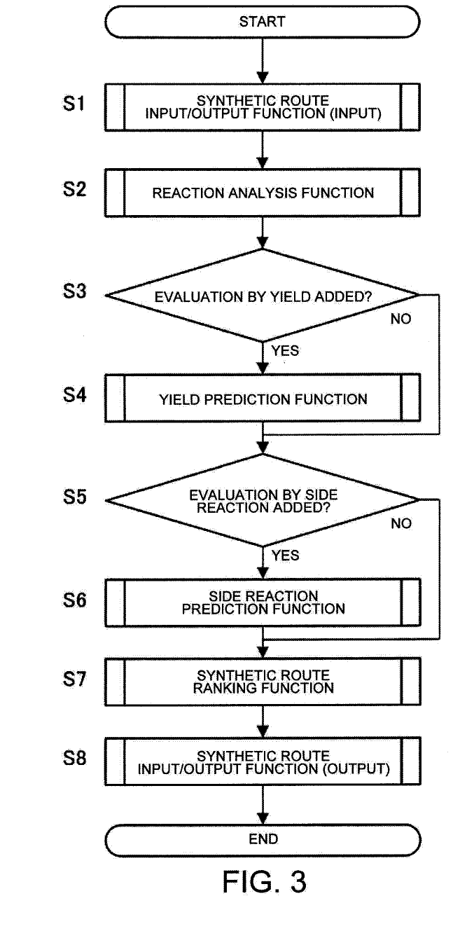

Next, with reference to FIG. 2 and FIG. 3 in addition, a description will be given of the function of the arithmetic processing device 3 and the flow of data processed by the arithmetic processing device 3.

FIG. 2 is a functional schematic view of the synthetic route evaluation system according to the embodiment. In FIG. 2, each part enclosed by a dotted line is each constituent of the arithmetic processing device 3 of the synthetic route evaluation system 1 shown in FIG. 1, and a function that can be fulfilled by each constituent is shown in each part enclosed thereby. FIG. 3 is a process flowchart of the synthetic route evaluation system according to the embodiment.

A synthetic route input/output function in FIG. 2 is a function that can be fulfilled by the whole of the synthetic route evaluation system 1, and, more specifically, it is a function that can be first fulfilled when the system is operated as shown in FIG. 3.

In the synthetic route evaluation system 1 according to the embodiment, the synthetic route input/output function of the arithmetic processing device 3 is first used, and data relative to synthetic routes is input from the input device 2 so as to be stored in the first storage device 4 as shown in step S1 of FIG. 3. More specifically, as shown in FIG. 2, user synthetic route data 15a and SRDS synthetic route data 15b are input via the input device 2, and are stored in the first storage device 4 in the form of synthetic route data 15. Herein, the term “SRDS” is an abbreviation of Synthesis Routes Designing System, and denotes a system that has already been put to practical use. In the SRDS, generally, a plurality of synthetic routes can be proposed, and are, however, increased in number in geometric progression if a reaction is considered in a multistage manner, and therefore there is a case in which a synthetic chemist will hesitate to make a selection from the synthetic routes even if the synthetic chemist is an experienced one. In other words, in a case in which a target synthetic substance is synthetically produced not by one reaction formula (single stage) but by a plurality of reaction formulas (multiple stages), a synthetic route can exist for each reaction, and therefore combinations thereof will be brought into a geometric-progression increase.

In the embodiment according to the present invention, user synthetic route data 15a set by a user of the synthetic route evaluation system 1 according to the embodiment of the claimed invention and SRDS synthetic route data 15b that can be created by the SRDS are both input via the input device 2 in the form of synthetic route data 15, and an analysis is performed using this data.

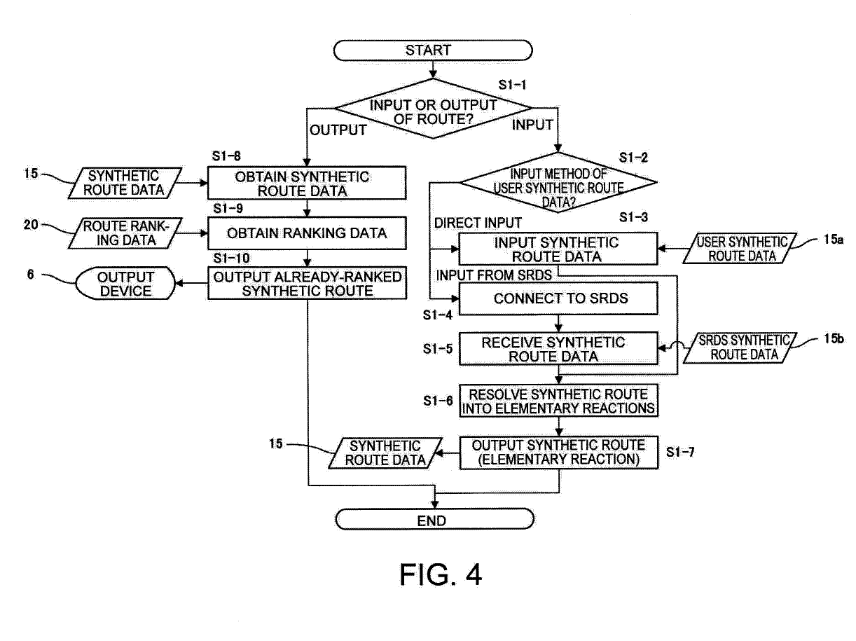

A detailed process flow in step S1 will be described with reference to FIG. 4. FIG. 4 is a process flowchart of the synthetic route input/output function in the arithmetic processing device of the synthetic route evaluation system according to the embodiment. In FIG. 4, at step S1-1 of determining whether synthetic routes are input or output, an automatic determination can be made by judging the timing of processing or the presence or absence of synthetic route data 15 to be output. In other words, for example, after starting the synthetic route evaluation system 1, synthetic route data 15 does not exist from that timing, and therefore it can be determined that synthetic routes are input, whereas there is a need to output synthetic route data 15 together with analysis results of a quantum chemical calculation, a reaction mechanism analysis, or an analysis of a yield prediction or of a side reaction prediction at the timing after completing these analyses, and therefore it can be determined that synthetic routes are output.

At step S1-2, a question about an input method of user synthetic route data is posed. It is possible to use two input methods, i.e., a method in which data is directly input by a user and a method in which data is input from the above-mentioned SRDS. This question is shown on a display of the output device 6, and can be input by the input device 2. If data is directly input by the user, the process proceeds to step S1-3, at which user synthetic route data 15a is input via the input device 2, such as a keyboard or a tablet, and, if it is selected that data is input from the SRDS, the input device 2 of the synthetic route evaluation system 1 is connected to the SRDS at step S1-4, and then SRDS synthetic route data 15b is received at step S1-5. The “connection of the input device 2 to the SRDS” denotes that an electrical connection for calling up information is made, and a wait for the information is performed in a state in which pieces of hardware, such as cables, have already been connected.

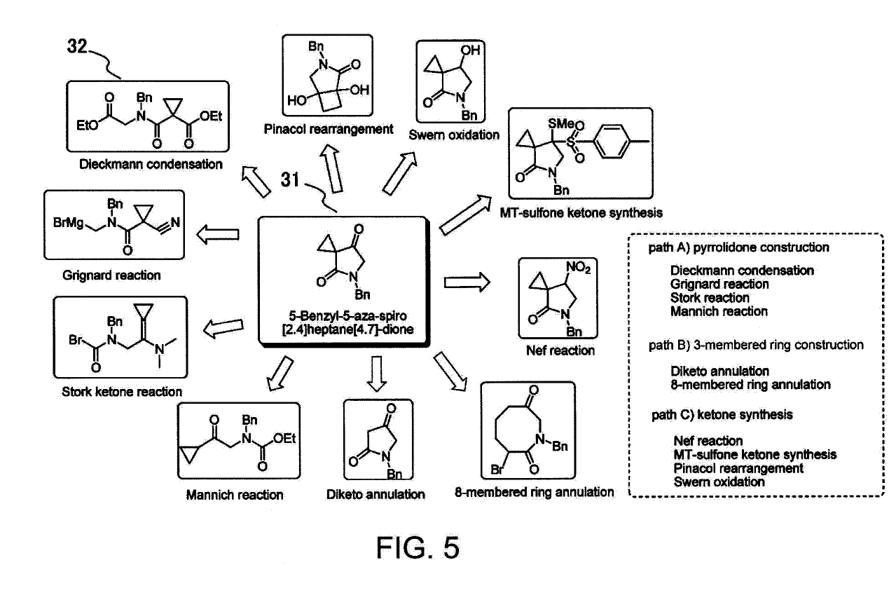

In either input method, the synthetic route data is provided in the form of a binary data type showing a route group indicated by the following two-dimensional structure. Herein, as shown in FIG. 5, an example of the synthetic route data by the SRDS of 5-Benzyl-5-aza-spiro[2.4] heptane[4.7]-dione is mentioned as the example.

FIG. 5 is a conceptual diagram of synthetic route data showing the relationship between a target compound (product) and starting compounds (reactants). A structure is shown in which first reactants 32 that are starting compounds are disposed around a product 31 expressed as 5-Benzyl-5-aza-spiro[2.4] heptane[4.7]-dione. If routes along which the product 31 is synthetically produced from these reactants 32 are classified according to the reaction type, there are three routes (paths) of A) a reaction of Pyrrolidone construction type, B) a reaction of 3-membered ring construction type, and C) a reaction of Ketone synthesis type as shown in FIG. 5. Synthetic route data 15 is formed as combinations of the target compound (product 31) and the plurality of starting compounds (reactants 32) used to synthetically produce the target compound. In the synthetic route data 15 shown in FIG. 5, ten reactants 32 exist with respect to the one product 31, and the data is composed of ten structure data pairs resulting from combinations of the product 31 and the reactants 32. The “structure data pair” will be hereinafter referred to simply as “structure data” if necessary.

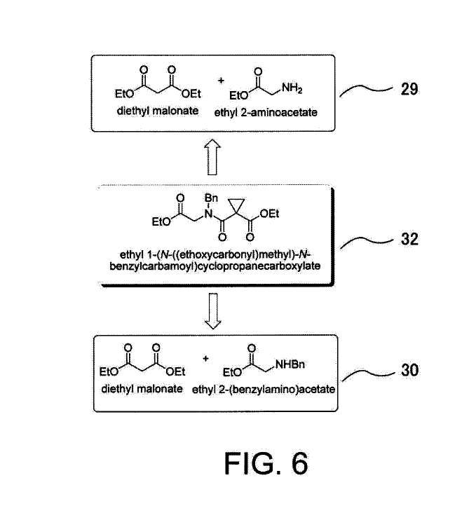

FIG. 6 shows an example of user synthetic route data relative to routes to generate reactants of a Dieckmann condensation reaction among the ten routes of FIG. 5.

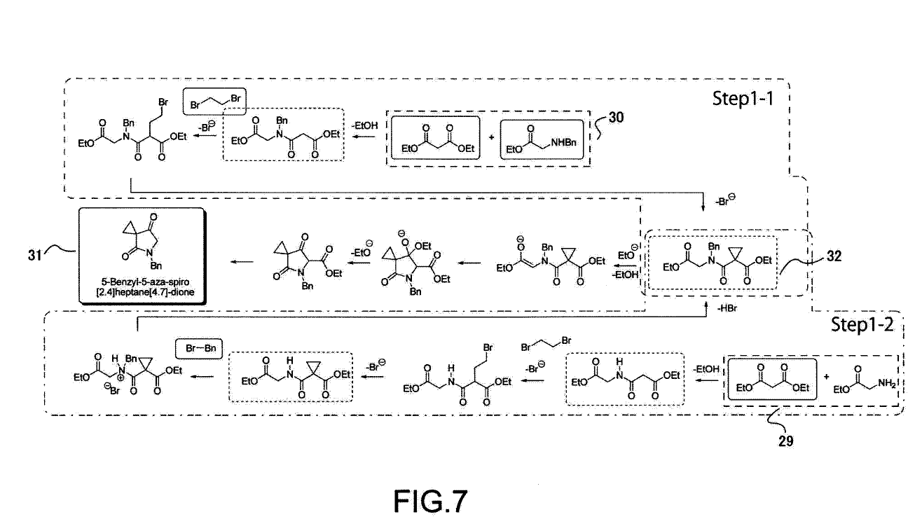

User synthetic route data 15a and SRDS synthetic route data 15b that have been input or received are resolved into elementary reaction routes as shown in step S1-6 of FIG. 4. Based on the user synthetic route data 15a and the SRDS synthetic route data 15b that have been input, the elementary reaction routes are automatically resolved, are then output to the first storage device 4 as synthetic route data 15 (step S1-7), and are stored therein. As shown in FIG. 7, the synthetic route data 15 is stored in the form of a binary data type showing an elementary reaction group for each route shown by a two-dimensional structure. FIG. 7 is a conceptual diagram of synthetic route data in a Dieckmann condensation reaction shown as the example. Information (synthetic route data 15) relative to the elementary reaction routes of the resolved synthetic routes may be displayed on the output device 6 for user convenience or may be output to an external device.

In FIG. 7, when a product 31 is synthetically produced, it is understood that there are two routes, i.e., a route in which a third reactant 32 is first synthetically produced from a first reactant 30, and then the product 31 is synthetically produced from the third reactant 32 as shown at Step1-1, and a route in which a third reactant 32 is synthetically produced from a second reactant 29, and then the product 31 is synthetically produced from the third reactant 32 as shown at Step1-2. Therefore, even if the data is synthetic route data 15 expressed by combining the product 31 and the reactants 32 together as shown in FIG. 5, it is important to recognize the possibility that a plurality of routes will be generated while resolving the data into elementary reactions, and the reason for the existence of step S1-6 mentioned above will be understood. Herein, the term “elementary reaction” denotes a reaction shown by an arrow (→) of, for example, in FIG. 7. Step1-1 is composed of three elementary reactions, and Step1-2 is composed of five elementary reactions.

An example of a method of resolving the synthetic route data 15 into elementary reactions is carried out in such a manner that data (elementary reaction data) relative to elementary reactions are pre-registered in a data base, are then read from the data base, are then compared and collated, and are resolved into elementary reactions included in the synthetic route data 15. If user synthetic route data 15a, SRDS synthetic route data 15b, etc., are pre-resolved into data for each elementary reaction, data resolved into elementary reactions are included in the synthetic route data 15 without changes, and therefore step S1-6 may be removed.

The accuracy of an analysis relative to synthetic routes can be heightened by resolving data into elementary reactions.

On the other hand, the output of synthetic routes is shown in detail in step S1-8 to step S1-10 of FIG. 4 although that is also shown in step S8 of FIG. 3. In this case, the process proceeds from step S1-1 to step S1-8, and the arithmetic processing device 3 reads and obtains the synthetic route data 15 stored in the first storage device 4. Likewise, route ranking data 20 stored in the first storage device 4 is read and obtained at step S1-9. Thereafter, at step S1-10, the arithmetic processing device 3 displays the synthetic route data 15 and the route ranking data 20 obtained therefrom on the output device 6, or outputs these data to an external device. The synthetic route data 15 mentioned here denotes data relative to routes already ranked by some factors.

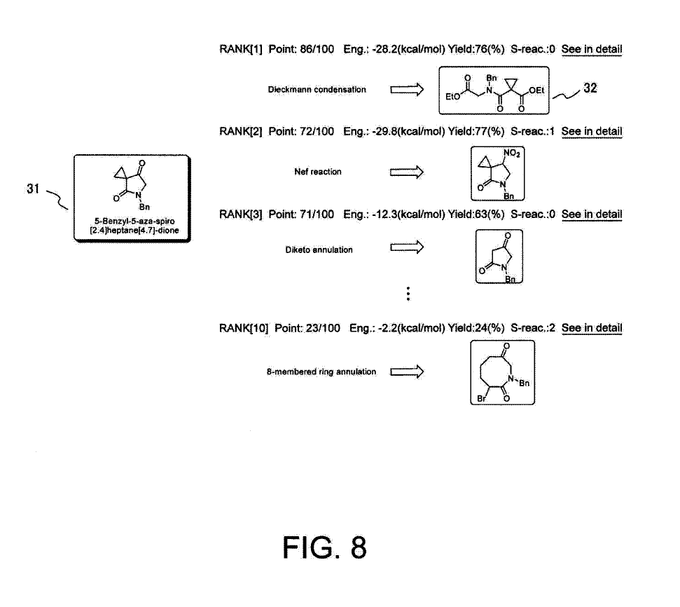

FIG. 8 is a conceptual diagram of the output of synthetic routes, which have been ranked, for a target compound. In FIG. 8, a target compound (product 31) is shown on the left, and starting compounds (reactants 32) used to synthetically produce this target compound are shown as RANK [1] to RANK [4], respectively. In FIG. 8, ranking is represented as, for example, points, and a route having the highest number of points is regarded as the best route. A user of the synthetic route evaluation system 1 according to the embodiment of the present invention can browse data relative to each calculation result based on which ranking points are determined, i.e., can browse reaction analysis data (Eng.: reaction heat of entire routes), predicted yield data (Yield: predicted yields), predicted side reaction data (S-reac.: number of predicted side reactions), etc., in addition to confirmation of the output of the ranking points as shown in FIG. 8.

Therefore, the user can select a presumably optimal route while comprehensively considering these pieces of data without being influenced by ranking points. Data is output in the form of a binary data type that shows synthetic route groups shown by a two-dimensional structure to which ranking points have been added as shown in FIG. 8. In FIG. 8, the output of an already-ranked route of 5-Benzyl-5-aza-spiro[2.4] heptane[4.7]-dione is shown as an example.

The arithmetic processing device 3 stores supplementary item data 19 input from the input device 2 in the first storage device 4 while using the synthetic route input/output function. This supplementary item data 19 is data relative to supplementary items for the evaluation of a ranking order that is used when the synthetic route ranking unit 11 fulfills a synthetic route ranking function (see FIG. 2).

Referring back to FIG. 1 to FIG. 3 and referring to a new process flowchart, a description will be hereinafter given of each analysis performed in the arithmetic processing device 3 of the synthetic route evaluation system 1 although, as above, a description has been given of the input of the user synthetic route data 15a and the SRDS synthetic route data 15b to the synthetic route evaluation system 1 and the data output after completing an analysis while placing a central focus on the input function and the output function of the synthetic route input/output function of the arithmetic processing device 3.

Synthetic route data 15 is stored in the first storage device 4 at step S1 of FIG. 3, and then the reaction mechanism analysis unit 8 can fulfill the reaction analysis function at step S2. A quantum chemistry calculation function described later is included in the reaction analysis function shown at step S2 of FIG. 3.

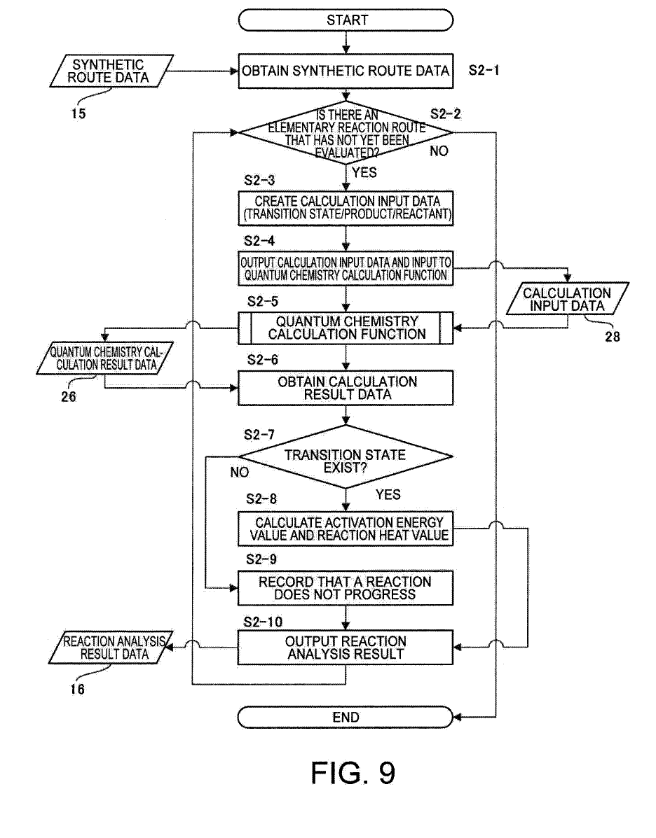

The reaction mechanism analysis unit 8 of the arithmetic processing device 3 of FIG. 2 executes a process flow shown in FIG. 9. FIG. 9 is a process flowchart of the reaction analysis function in the arithmetic processing device of the synthetic route evaluation system according to the embodiment.

First, the reaction mechanism analysis unit 8 reads synthetic route data 15 stored in the first storage device 4 (step S2-1), and searches for the presence or absence of elementary reaction routes, which have not been evaluated, among elementary reactions included in the synthetic route data 15 (step S2-2). The “evaluation” mentioned here denotes that data corresponding to the quantum chemistry calculation result data 26 and the reaction analysis result data 16, which can be obtained through step S2-3 and steps subsequent to step S2-3, have already been obtained. Therefore, if elementary reaction routes that have not been evaluated do not exist at step S2-2, the process proceeds directly to End, and the process flow relative to the reaction analysis function at step S2 is completed.

On the other hand, if elementary reaction routes that have not been evaluated exist, the process proceeds to step S2-2, at which a quantum chemical calculation and a reaction analysis are performed, and quantum chemistry calculation result data 26 and reaction analysis result data 16 are obtained.

Referring to FIG. 2 and FIG. 9 to FIG. 17, a description will be hereinafter given of the reaction analysis function (step S2 of FIG. 3) that can be fulfilled by the reaction mechanism analysis unit 8 and the quantum chemistry calculation unit 7.

In FIG. 9, if elementary reaction routes that have not been evaluated exist at step S2-2, the reaction mechanism analysis unit 8 of the arithmetic processing device 3 creates a structure data pair of the product 31 and the reactant 32 in the elementary reaction route that have not been evaluated and structure data (transition state structure data) relative to a transition state in this elementary reaction route from the synthetic route data 15 previously read from the first storage device 4. This transition state structure data is created by using the structure data pair consisting of the product 31 and the reactant 32 regardless of the presence or absence of a transition state in the elementary reaction route. For example, a mean value is taken from structure data about the product 31 and the reactant 32, and is employed as transition state structure data. There is another conceivable method in which averaging is achieved by weighting a component of each structure data without employing a mean value. In other words, based merely on a structural calculation, temporary structure data is calculated without determining whether a transition state exists in an elementary reaction route. A calculation for a transition-state-similar structure or for optimizing a structure to a transition state is performed by using such transition state structure data as described later.

The creation of calculation input data at step S2-3 denotes that two-dimensional synthetic route data 15 is converted into three-dimensional data in order to perform a quantum chemical calculation or that a computer fixes an appointment in conformity with a calculation environment when a quantum chemical calculation is performed.

In the reaction analysis function fulfilled in the reaction mechanism analysis unit 8, data relative to synthetic routes for performing a reaction analysis is obtained, and all elementary reaction routes that have not been evaluated are subjected to reaction analysis processing. Calculation input data 28 relative to structure data about the product 31, about the reactants 32, and about the transition state is created in an ASCII form in which keyword groups (data) necessary for three-dimensional structure coordinates and quantum chemical calculations are recorded. For example, wave function kind data (RHF, B3LYP, MP2, etc.) used for a quantum chemical calculation, base function kind data (6-31G*, LANL2DZ, etc.), and calculation type data (structural optimization, structural optimization to a transition state, an oscillation calculation, a mere energy calculation, etc.) are included in the keyword groups (data) necessary for a quantum chemical calculation.

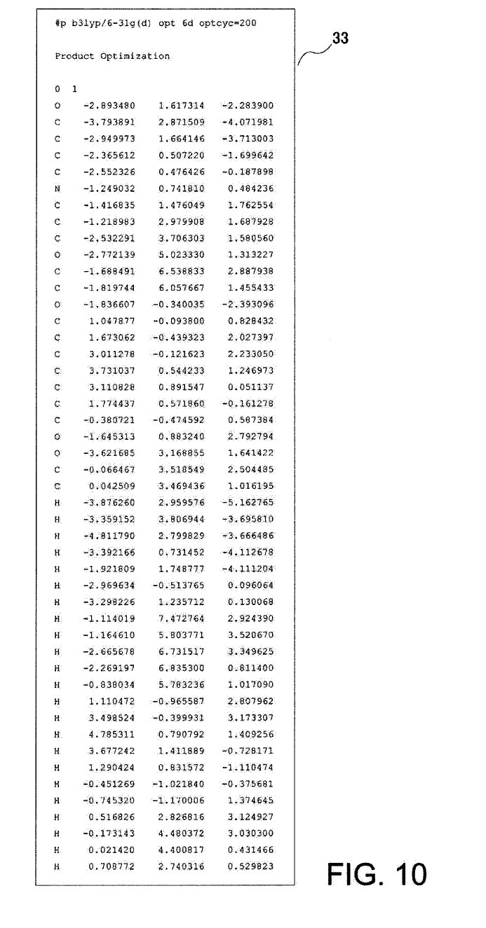

FIG. 10 shows a calculation input data structure 33 of a calculation input file of ethyl 1-(N-((ethoxycarbonyl)methyl)-N-benzylcarbamoyl) cyclopropa necarboxylate, which is a product in the first stage of a Dieckmann condensation route, as an example of the calculation input data 28.

In FIG. 10, atomic symbols are shown on the extreme left, and three pieces of data on the right thereof respectively show coordinate points on the orthogonal coordinates based on a three-dimensional structure. The order from above is based on the order (number) of atoms arbitrarily specified by a user. Therefore, this order is not fixed, and may be appropriately determined by the user. The above-mentioned keyword group (data) necessary for a quantum chemical calculation is shown at the uppermost row. More specifically, “b3lyp” designates wave function data, and “6-31g” designates base function kind data. Additionally, “opt” designates data for a structural optimization calculation.

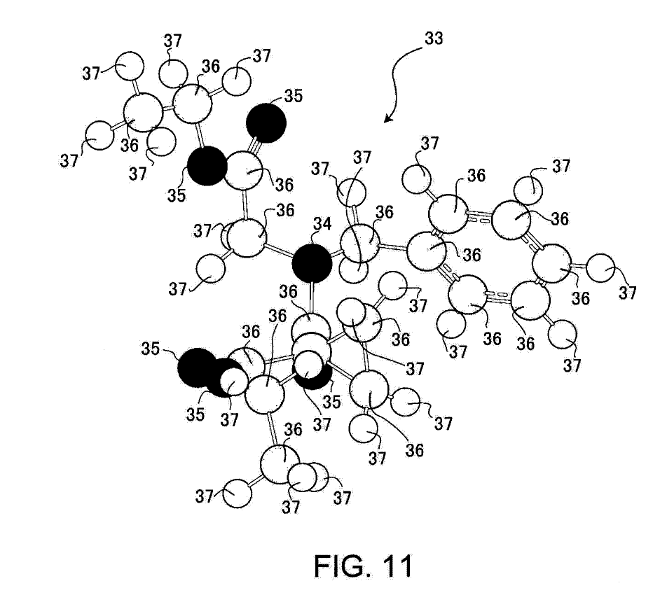

FIG. 11 is a conceptual diagram that three-dimensionally shows the calculation input data structure 33 of the calculation input file of the product in the first stage of the synthetic route in the Dieckmann condensation reaction shown in FIG. 10. In FIG. 11, reference numerals 34, 35, 36, and 37 designate a nitrogen atom 34, an oxygen atom 35, a carbon atom 36, and a hydrogen atom 37, respectively.

Created calculation input data 28 is transmitted from the reaction mechanism analysis unit 8 to the quantum chemistry calculation unit 7 at step S2-4, and a calculation is performed by the quantum chemistry calculation unit 7 that has received the calculation input data 28 at step S2-5.

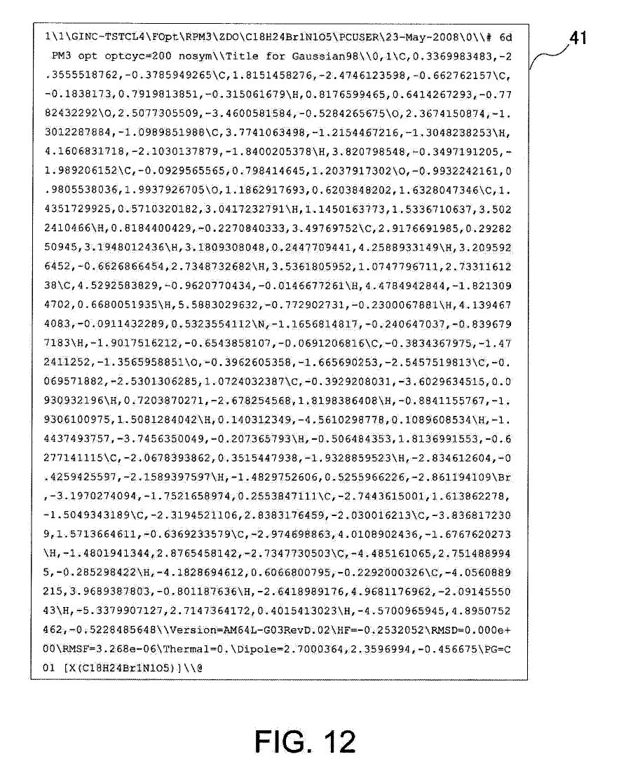

When the calculation performed by the quantum chemistry calculation unit 7 is completed, the quantum chemistry calculation unit 7 forms a calculation result file including the quantum chemistry calculation result data 26. The quantum chemistry calculation result data 26 is created in an ASCII form including the output of a halfway calculation process and the like. An example of this quantum chemistry calculation result data 26 is shown in FIG. 12. FIG. 12 is a conceptual diagram showing an archive part of the file of the quantum chemistry calculation result data of the product in the first stage of the synthetic route in the Dieckmann condensation reaction.

The quantum chemistry calculation result data 26 is stored in the second storage device 5 by the quantum chemistry calculation unit 7 as shown in FIG. 1.

Thereafter, the quantum chemistry calculation unit 7 reads the quantum chemistry calculation result data 26 obtained as a result of a calculation from the second storage device 5, and checks whether the transition state of a reaction exists in the elementary reaction route by use of calculation result data relative to transition states included in the quantum chemistry calculation result data 26 (step S2-7). If a transition state exists, an activation energy value and reaction heat in this transition state are calculated by use of calculation result data relative to transition states included in the quantum chemistry calculation result data 26, calculation result data relative to reactants, and calculation result data relative to products (step S2-8), and are output as reaction analysis result data 16 (step S2-10).

If a transition state does not exist, the quantum chemistry calculation unit 7 regards this reaction as not progressing, and allows the output device 6 to output a signal showing that the reaction does not progress in the reaction analysis result data, and transmits information to a user by displaying its contents (step S2-9).

The reaction analysis result data 16 output therefrom is stored in the first storage device 4 in a table form. Data relative to two reaction analysis results corresponding to the first stage of Dieckmann condensation is shown in Table 1 as an example of this reaction analysis result data 16. Step-1 and Step-2 included in Table 1 are common to the steps shown in FIG. 7, respectively. Reaction analysis result data 16 relative to each step is shown in Table 1. Num designates a number to specify a transition state, Level designates a combination of the base function and the kind of the wave function used when a quantum chemical calculation is performed, Reac [a.u.] designates a value shown in each atom of all energy of the reactants 32, Prod [a.u.] designates a value shown in each atom of all energy of the product 31, Ea [kcal/mol] designates the activation energy of each transition state, and ΔE [kcal/mol] designates reaction heat before and after a transition state.

[Table 1]

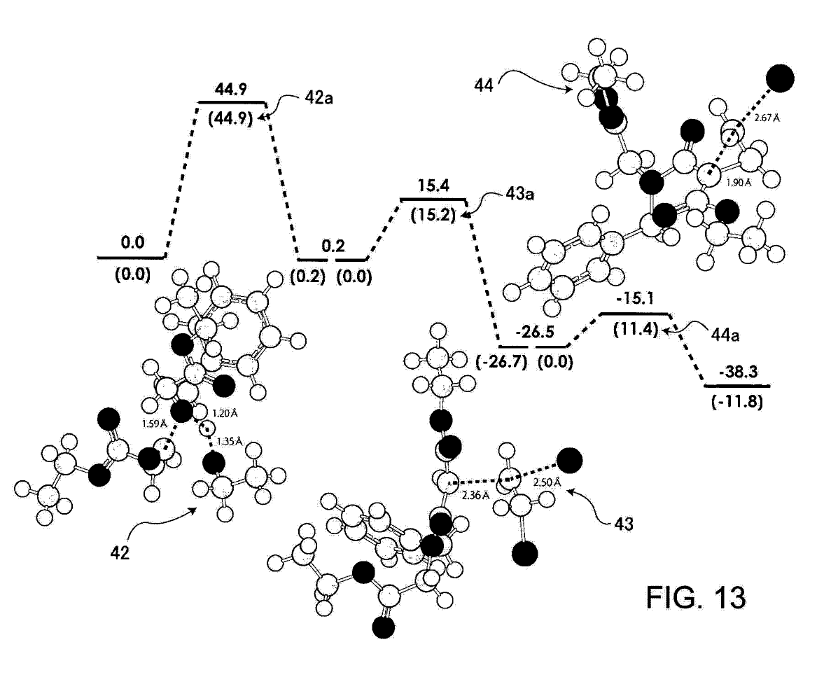

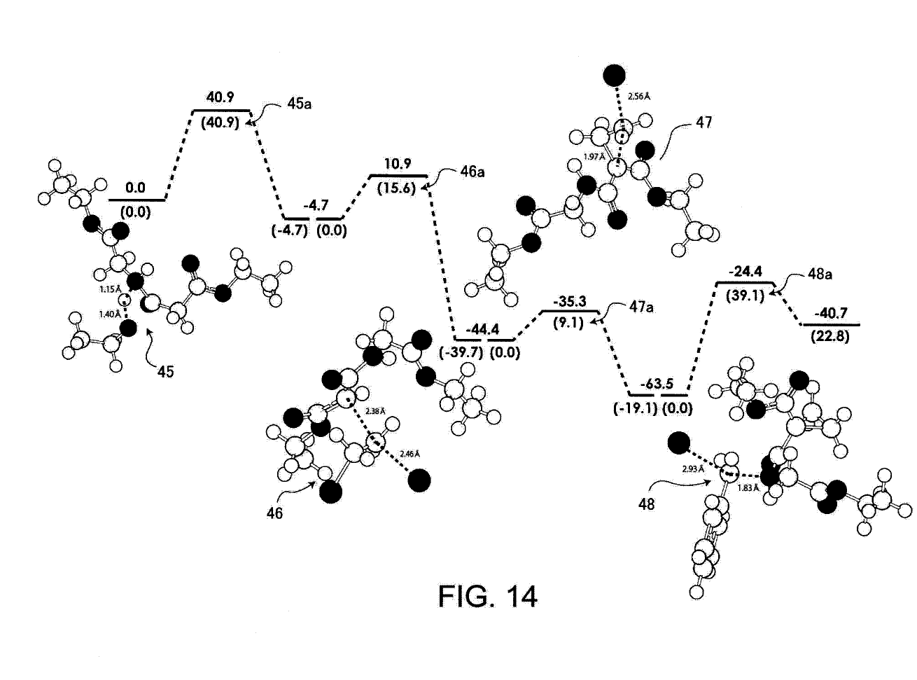

FIG. 13 is a conceptual diagram obtained by visualizing Step-1 of Table 1 of two pieces of reaction analysis data in the second stage of the synthetic route in a Dieckmann condensation reaction, and likewise, FIG. 14 is a conceptual diagram obtained by visualizing Step-2 of two pieces of reaction analysis data in the second stage of the synthetic route in a Dieckmann condensation reaction.

The figure shows the fact that there are three transition states, i.e., a first transition state 42, a second transition state 43, and a third transition state 44 in the elementary reaction route shown at Step-1 as also shown in Table 1, and the activation energy in each transition state is represented as activation energy 42a, activation energy 43a, and activation energy 44a in FIG. 13.

Likewise, the figure shows the fact that there are four transition states, i.e., a first transition state 45, a second transition state 46, a third transition state 47, and a fourth transition state 48 in the elementary reaction route shown at Step-2 as shown in Table 1, and the activation energy in each transition state is represented as activation energy 45a, activation energy 46a, activation energy 47a, and activation energy 48a in FIG. 14.

The above-mentioned reaction analysis is performed about all elementary reaction routes, and the reaction analysis function is ended.

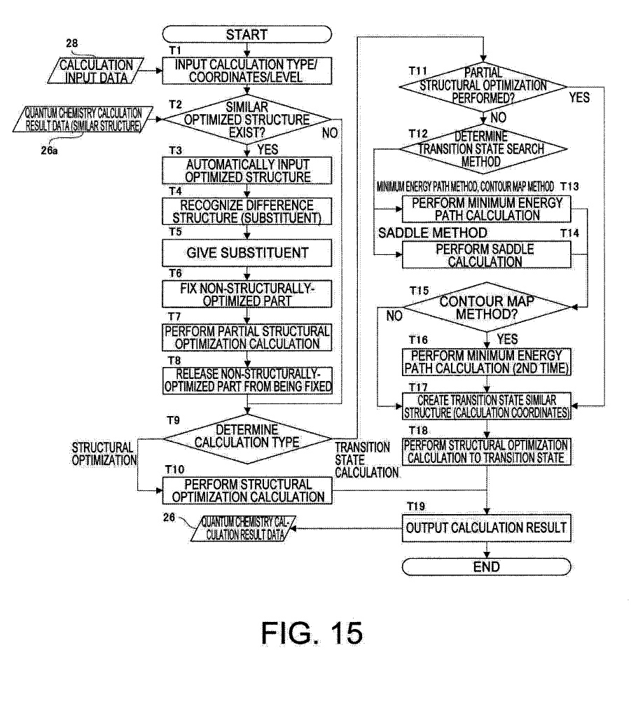

As above, a description has been given of the reaction analysis function in the reaction mechanism analysis unit 8 of the synthetic route evaluation system 1 according to the embodiment with reference to the process flowchart of FIG. 9. Next, a description will be provided of the quantum chemistry calculation function shown in step S2-5 of FIG. 9 with reference to FIG. 15.

FIG. 15 is a process flowchart of the quantum chemistry calculation function in the arithmetic processing device of the synthetic route evaluation system according to the embodiment. Processing with the quantum chemistry calculation function is performed in the quantum chemistry calculation unit 7 of the arithmetic processing device 3. At step S2-4 of FIG. 9, the quantum chemistry calculation unit 7 that has received a transmission of the calculation input data 28 from the reaction mechanism analysis unit 8 reads calculation type data, coordinate data relative to the structure of the reactants 32 and that of the product 31 at step T1, and level data from the calculation input data 28. As described above, the calculation type data is data relative to whether to perform calculations, such as an oscillation calculation or an energy calculation, in addition to a calculation relative to structural optimization or a calculation relative to the transition state search function. The level data is data in which the wave function data and the base function data mentioned above are combined with each other.

At step T2, while referring to the level data and the coordinate data relative to the structure of the reactants 32 and that of the product 31 read at step T1 as a key, the quantum chemistry calculation unit 7 searches whether data has already been stored in the second storage device 5 as quantum chemistry calculation result data 26a having a similar optimized structure. If a similar optimized structure is found by this search, the quantum chemistry calculation unit 7 reads the quantum chemistry calculation result data 26a relative to the similar optimized structure from the second storage device 5, and inputs the data to itself (step T3).

This quantum chemistry calculation result data 26a takes a data structure having a table form, and is stored in the second storage device 5. An example of the quantum chemistry calculation result data 26a relative to a Dieckmann condensation reaction is shown in Table 2. Likewise, the same data as the calculation input data 28 is included in the quantum chemistry calculation result data 26a.

[Table 2]

Furthermore, the quantum chemistry calculation unit 7 calculates a difference between the structure of a reactant to execute the structural optimization included in the calculation input data 28 and the optimized structure of a similar reactant included in the quantum chemistry calculation result data 26a, and searches and recognizes its difference structure, i.e., the structure of a substituent (step T4). This difference is recognized by a difference in the number/type of atoms that are constituents of reactants included in the calculation input data 28 and in the quantum chemistry calculation result data 26a and by a difference in a connective relationship.

If the quantum chemistry calculation unit 7 recognizes a substituent lacking in a similar optimized structure at step T4, this substituent is given to the similar optimized structure (step T5). The number of substituents lacking therein is not limited to one, and is two or more in some cases. If the substituent is given, a part to which this substituent has been given will not have an optimized structure, and therefore only this part will be optimized. Accordingly, a difference with the optimized structure of the similar reactant is calculated, and, as a result, an analysis can be performed by giving a substituent, and therefore a very efficient analysis becomes possible.

Therefore, at step T6, the quantum chemistry calculation unit 7 fixes parts other than the part to which the substituent has been given as non-structurally-optimized parts, and specifies the part to which the substituent has been given as a structurally optimized part, and executes partial structural optimization by use of the structural optimization function built into the quantum chemistry calculation unit 7 (step T7).

The structure of atoms in the part to which the substituent has been given is optimized by performing a partial structural optimization calculation. The structural optimization is achieved by repeatedly performing an SCF (Self Consistent Field) calculation for obtaining all energy of the structure and an operation for changing the structure. The SCF calculation is a general method for a quantum chemical calculation performed to obtain all energy of the structure by use of a wave function and a base function. While calculating all energy with respect to a plurality of structures, a local minimum point of energy is calculated according to an energy gradient method based on a Newton algorithm, a Monte Carlo algorithm, etc. Optimization is achieved when this local minimum point is reached. In other words, the structural optimization calculation denotes the performance of the SCF calculation mentioned above, and the function for performing this series of calculations is called a structural optimization function in this claimed invention.

Thereafter, at step T9, the quantum chemistry calculation unit 7 reads calculation type data included in the calculation input data 28, and draws a distinction between the calculation types. If the calculation type data is data relative to structural optimization, the process proceeds to step T10, at which a calculation for structural optimization is performed. A calculation result of the structural optimization is output at step T19, and is stored in the second storage device 5 by the quantum chemistry calculation unit 7 as quantum chemistry calculation result data 26.

On the other hand, if the calculation type data is data relative to a transition state calculation, the process proceeds to step T11, at which a transition state calculation is performed.

At step T11, if a calculation for partial structural optimization has already been performed at step T7 previous thereto, the process proceeds to step T17, at which transition-state-similar structure data is created without performing a search included in the transition state calculation. The reason is that, in this case, it is understood that a similar optimized structure has already existed, and a structural optimization calculation to a transition state has also been completed in this similar optimized structure, and hence data (transition-state-similar structure data) relative to a structure similar to a transition state can be obtained when a partial structural optimization calculation is ended by giving a substituent. The transition-state-similar structure is not an optimized transition state structure, and denotes a structure at a stage previous to performing a calculation for optimization.

On the other hand, if the partial structural optimization calculation is not performed at step T11, the process proceeds to step T12, at which the quantum chemistry calculation unit 7 draws a distinction between transition state search methods. If the partial structural optimization calculation is not performed, the presence or absence of a transition state is not recognized, and hence transition-state-similar structure data has not yet been formed, and therefore transition-state-similar structure data is formed while searching for a transition state.

Examples of methods for searching for a transition state include a minimum energy path method, a contour map method, and a saddle method as mentioned at steps T13 and T14 of FIG. 15. Among these methods, a minimum energy path calculation is performed at step T13 according to the minimum energy path method and the contour map method, whereas a saddle calculation is performed at step T14 according to the saddle method. These calculation methods are performed by use of functions, respectively, and each of the function is referred to as a transition state search function in this claimed invention. The quantum chemistry calculation unit 7 includes these transition state search functions built thereinto, and performs a calculation in such a manner as to substitute structure data relative to reactants and products in synthetic routes into these transition state search functions, and, as a result, obtains transition state structure data (transition-state-similar structure data) and data relative to the presence or absence of a transition state. This calculation method itself is already known well, and therefore the contents of the calculation are not especially described in this claimed invention.

The process proceeds from steps T13 and T14 to step T15, at which a minimum energy path calculation is performed once for two directions, i.e., is performed two times in total according to the contour map method, and, of course, it is possible to employ a flowchart having three situations divided into the above-mentioned minimum energy path method, the contour map method, and the saddle method, respectively.

If the contour map method is employed at step T15, a second minimum energy path calculation is performed at step T16, and, if the methods other than the contour map method are employed, the process proceeds to step T17. If the second minimum energy path calculation is performed at step T16, the process likewise proceeds to step T17.

A search for a transition state can be conducted by performing steps T12 to T16 and obtaining the result as described above. In other words, the presence or absence of a transition state can be determined.

If it is determined that a transition state exists, the quantum chemistry calculation unit 7 forms transition-state-similar structure data from the calculation result, then outputs this data as quantum chemistry calculation result data 26, and stores the data in the second storage device 5. The quantum chemistry calculation unit 7 may transmit the contents of the quantum chemistry calculation result data 26 to the output device 6 so as to be displayed, or may output the data to an external device.

Each transition state search method (transition state search function) is carried out, and, as a result, a plurality of structures each of which is expected to have a transition state are generated from a series of reactions from reactants to products, and all energy in each of the structures is calculated, and one of the structures having the highest energy is regarded as a transition-state-similar structure. Accordingly, coordinates of this transition-state-similar structure are obtained, and are used as calculation coordinates (step T17).

After obtaining the calculation coordinates as a transition-state-similar structure at step T17, the quantum chemistry calculation unit 7 performs a structural optimization calculation to a transition state at step T18. The contents of the structural optimization calculation are the same as described above. The calculation result is output at step T19, and may be displayed though the output device 6 as quantum chemistry calculation result data 26, or may be output to an external device via the output device 6. The quantum chemistry calculation unit 7 stores the quantum chemistry calculation result data 26 in the second storage device 5.

In the embodiment, a structural optimization calculation is performed from transition state structure data (transition-state-similar structure data) at step T18, and, as a result of this calculation, it is possible to obtain transition state structure data with higher accuracy for the same calculation time or with the same accuracy for a shorter calculation time, and, in addition, it is possible to heighten the accuracy of a synthetic route evaluation. If simplification is allowed and if accuracy is ignored, quantum chemistry calculation result data 26 may be formed without performing a structural optimization calculation by use of transition state structure data (transition-state-similar structure data). However, if so, accuracy will become lower than at step T18 as described above.

If a similar optimized structure does not exist in quantum chemistry calculation result data 26a at step T2 of FIG. 15, steps T3 to T8 are not executed, and the process proceeds to step T9, at which calculation type data is read from the calculation input data 28, and a calculation type is determined.

Steps ranging from step T3 to step T9 are executed, and, as a result, a calculation time required for structural optimization or for a transition state search at the following steps can be shortened. In other words, the use of a similar optimized structure makes it possible to optimize only a part to which a substituent has been given and shorten a calculation time for the entire optimization.

As above, a description has been given of the quantum chemistry calculation function fulfilled by the quantum chemistry calculation unit 7 of the arithmetic processing device 3 at step S2-5 of FIG. 9. Referring back to FIG. 9, the quantum chemistry calculation result data 26 obtained at step S2-5 (step T19 of FIG. 15) is read by the reaction mechanism analysis unit 8 (step S2-6).

Whether a transition state exists is determined by searching for the transition state structure data in this quantum chemistry calculation result data 26 (step S2-7). If a transition state exists, the reaction mechanism analysis unit substitutes optimized reactant structure data, product structure data, and transition state structure data into the activation energy calculation function built in itself, and calculates an activation energy value and/or a reaction heat value at step S2-8.

On the other hand, if a transition state does not exist, the reaction mechanism analysis unit 8 determines that a reaction does not progress, and records this fact onto the quantum chemistry calculation result data 26 (step S2-9).

Both of or either of the activation energy value and the reaction heat value calculated at step S2-8 is output by the reaction mechanism analysis unit 8 as a reaction analysis result at step S2-10, and the reaction analysis result data 16 is stored in the first storage device 4. If it is determined that a reaction does not progress at step S2-9, the process likewise proceeds to step S2-10, at which the fact that a reaction does not progress is output as a result, because there is no transition state. Although the reaction analysis result data 16 is stored in the first storage device 4, a signal may be output by the reaction mechanism analysis unit 8 to the output device 6 so as to display the contents of the reaction analysis result data 16, or may be transmitted to an external device.

The reason why a processing line for going up again to step S2-2 exists at step S2-10 is that processing in the reaction mechanism analysis unit 8 and the quantum chemistry calculation unit 7 gives consideration to a case in which there are a plurality of elementary reaction routes and that steps ranging from step S2-2 to step S2-10 are executed for all of the elementary reaction routes.

A description of the process up to step S2 of FIG. 2 is finished here.

Next, as shown in FIG. 2, it is determined at step S3 whether an evaluation by yields is required, thereafter the process flow of a yield prediction function is shown at step S4, thereafter it is determined at step S5 subsequent thereto whether an evaluation by side reactions is required, and the process flow of a side reaction prediction function is shown at step S6. In the synthetic route evaluation system 1, these functions are chosen and fulfilled, and the synthetic route ranking function is fulfilled at step S7, so that an evaluation of which synthetic route is most desirable is performed and output (step S8).

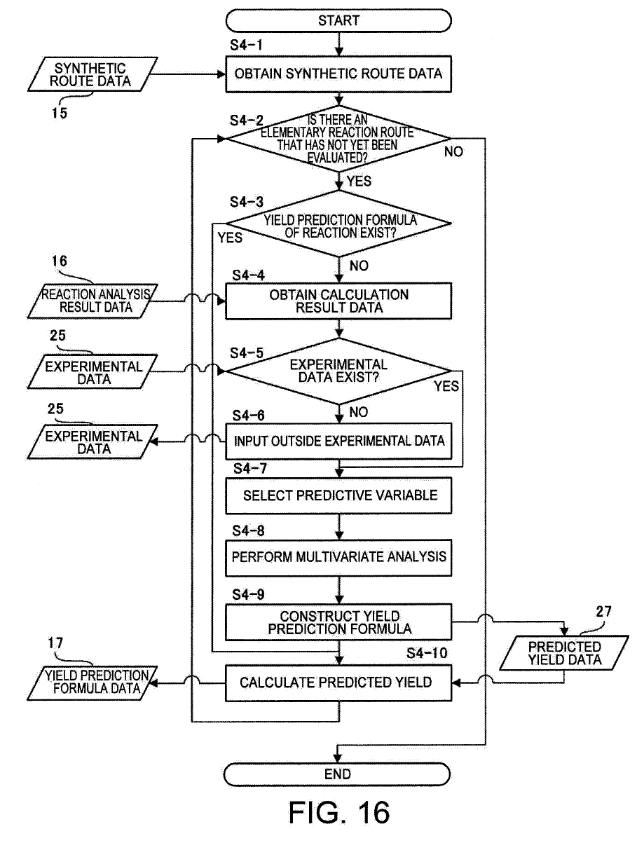

Next, step S4 of FIG. 2 mentioned above will be described with reference to FIG. 16.

FIG. 16 is a process flowchart of the reaction yield prediction function in the yield prediction unit of the arithmetic processing device of the synthetic route evaluation system according to the embodiment.

The yield prediction unit 9 of the arithmetic processing device 3 reads and obtains synthetic route data 15 from the first storage device 4 at step S4-1. Thereafter, whether an elementary reaction route whose yield has not yet been evaluated exists is searched (step S4-2). If it does not exist, a calculation for a predicted yield can be regarded as having already been ended, and therefore processing by the yield prediction unit 9 is ended in that state. A subsequent analysis can be efficiently carried out by pre-checking the presence or absence of an elementary reaction route that has not yet been evaluated at step S4-2.

On the other hand, if an elementary reaction route that has not yet been evaluated does not exist, a predicted yield is evaluated. The yield prediction unit 9 searches for yield prediction formula data 27 pre-stored in the second storage device 5, and inspects the existence of a yield prediction formula in a reaction relative to the synthetic route data 15 in the yield prediction formula data 27 (step S4-3).

If an elementary reaction route that has not yet been evaluated exists, the process proceeds to step S4-10, at which the yield prediction unit 9 reads the yield prediction formula, and substitutes a reactant and a structure data pair of the reactant into the formula, and, as a result, predicted yield data 17 is obtained by calculating the predicted yield. This predicted yield data 17 is stored in the first storage device 4 by the yield prediction unit 9. This data may be displayed via the output device 6, or may be output to an external device.

If a yield prediction formula is not present in the yield prediction formula data 27 in which the yield prediction formula is pre-stored at step S4-3, the yield prediction unit 9 reads and obtains reaction analysis result data 16 from the first storage device 4 at step S4-4. Thereafter, to determine the presence or absence of experimental data 25 relative to the same reaction as the elementary reaction route at step S4-5, the second storage device 5 is accessed, and the experimental data 25 pre-stored therein is searched. If the experimental data 25 is present therein, this experimental data 25 relative to the reaction of the elementary reaction route is read. Likewise, the existence of the yield prediction formula of a reaction is pre-checked at step S4-3, and therefore a subsequent analysis can be performed according to the presence or absence thereof, thus making it possible to perform an efficient analysis.

The experimental data 25 is stored in the form of a table. Herein, as one example, a part of the experimental data of a similar reaction relative to Dieckmann condensation is shown in Table 3. With respect to items arranged in a row herein, “Exp. Num.” designates an experimental number, “Yield” designates an experimental yield, “Temp.” designates an experimental temperature, “Time” designates an experimental time, “a” designates the initial concentration of a solute when an experiment starts, and “ε” designates the dielectric constant of a solvent.

[Table 3]

To perform a multivariate analysis when reaction analysis data and experimental data become ready to be used, the yield prediction unit 9 selects a predictive variable (step S4-7), and performs a multivariate analysis (step S4-8). It is recommended to pre-store this predictive variable in the second storage device 5 as apart of the yield prediction formula data 27.

On the other hand, if experimental data is not included in the experimental data 25 pre-stored at step S4-5 and if the same or similar experimental data exists in outside experimental data, the yield prediction unit 9 inputs the experimental data 25 from the outside experimental data at step S4-6, then likewise selects a predictive variable at step S4-7, and performs a multivariate analysis (step S4-8). It is recommended to allow a function relative to the multivariate analysis to be pre-included in the yield prediction formula data 27, or to be solely stored in the first storage device 4 or the second storage device 5 so that the yield prediction unit 9 reads and analyzes this function, or to be built in the yield prediction unit 9 itself. If experimental data 25 pre-stored therein does not exist, the same or similar experimental data is input to outside experimental data, and therefore a higher general-purpose analysis can be performed.

The yield prediction unit 9 constructs a yield prediction formula based on the result of the above-mentioned multivariate analysis (step S4-9). The yield prediction formula constructed based thereon depends on how the predictive variable is selected and depends on the multivariate analysis result, and, for example, is expressed as follows. Herein, “Zcalc” designates a predicted yield, “E” designates the dielectric constant of a solvent obtained from experimental data, “t” designates a reaction time obtained from experimental data, “R” designates a gas constant, “T” designates a reaction temperature obtained from the experimental data 25, “Ea” designates activation energy obtained from the reaction analysis result data 16, and “A”, “B”, “C”, and “D” designate constant values obtained from a multivariate analysis, respectively. The constructed yield prediction formula data 27 is stored in the second storage device 5 by the yield prediction unit 9. The yield prediction unit 9 may display the data via the output device 6 or may output the data to an external device.

[Formula 1]

The yield prediction formula data 27 is stored in the form of a table. Herein, as one example, the yield prediction formula data 27 relative to four reactions including that of Dieckmann condensation is shown in Table 4.

TABLE 4
Number of terms

Constant A
Constant B
Constant C
Constant D
Product of A term
Product of B term
Product of C term
Product of D term

Thereafter, the yield prediction unit 9 predicts the yield of this reaction by use of the yield prediction formula data 27 (step S4-10). The predicted yield is stored in the first storage device 4 as predicted yield data 17. The predicted yield data 17 is stored in the form of a table that shows a yield with respect to each elementary reaction route. Herein, as one example, the predicted yield data 17 relative to two routes that correspond to the first stage of Dieckmann condensation is shown in Table 5.

[Table 5]

When the yield prediction is completed with respect to all routes, the reaction yield prediction function is ended. In other words, when completed, step S4 of FIG. 3 is ended.

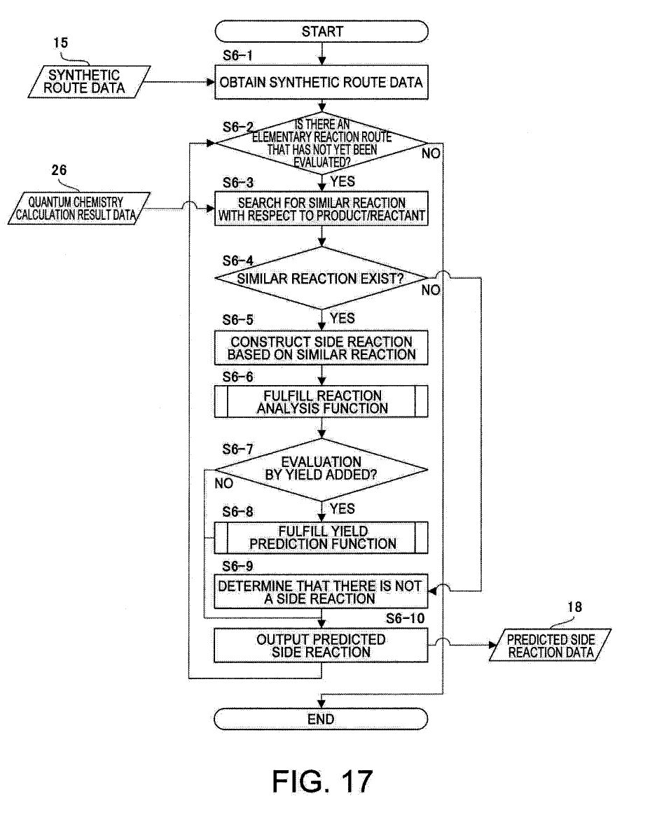

Next, step S6 of FIG. 2 mentioned above will be described with reference to FIG. 17.

FIG. 17 is a process flowchart of the side reaction prediction function in the side reaction prediction unit of the arithmetic processing device of the synthetic route evaluation system according to the embodiment.

The side reaction prediction unit 10 obtains synthetic route data from the first storage device 4 at step S6-1. Thereafter, the presence or absence of an elementary reaction route in which a side reaction has not yet been evaluated is searched (step S6-2). If this elementary reaction route is absent, a calculation of the side reaction can be regarded as having already been ended, and therefore processing by the side reaction prediction unit 10 is ended in that state.

On the other hand, if an elementary reaction route that has not yet been evaluated does not exist, the side reaction is evaluated. The side reaction prediction unit 10 searches for the quantum chemistry calculation result data 26 pre-stored in the second storage device 5, and the presence or absence of a similar reaction with respect to products and reactants in this quantum chemistry calculation result data 26 is searched (step S6-3). If a similar reaction is detected, it is determined that a side reaction exists (step S6-4), and a side reaction relative to a reaction of that elementary reaction route is constructed based on the similar reaction (step S6-5). A reaction analysis of the thus constructed side reaction is performed at step S6-6. This reaction analysis is the processing of step S2 of FIG. 3. The “construction” mentioned here denotes that the side reaction relative to the similar reaction is directly extracted as a side reaction of an elementary reaction route that is being analyzed.

It is determined at step S6-7 whether an evaluation by yields is required. If required, processing by the yield prediction unit 9 is performed at step S6-8 as already described with reference to FIG. 16.

If the evaluation of a yield at step S6-8 is ended and if an evaluation by yields at step S6-7 is not performed, the side reaction prediction unit 10 outputs the constructed side reaction (step S6-10), and stores this in the first storage device 4 as predicted side reaction data 18. The side reaction prediction unit 10 may display the predicted side reaction data 18 via the output device 6 or may transmit this data to an external device.

If there is no similar reaction at step S6-4, the process proceeds to step S6-9, at which the side reaction prediction unit 10 determines that there is no side reaction, and the process proceeds to step S6-10. Herein, a result to the effect that there is no side reaction is output as a piece of information, and is likewise stored in the first storage device 4 as predicted side reaction data 18. In the same way as above, the predicted side reaction data 18 may be displayed via the output device 6 or may be transmitted to an external device.

If the number of side reactions and a yield prediction about the side reactions are analyzed, data relative to the predicted yield about the side reactions is also included in the predicted side reaction data 18.

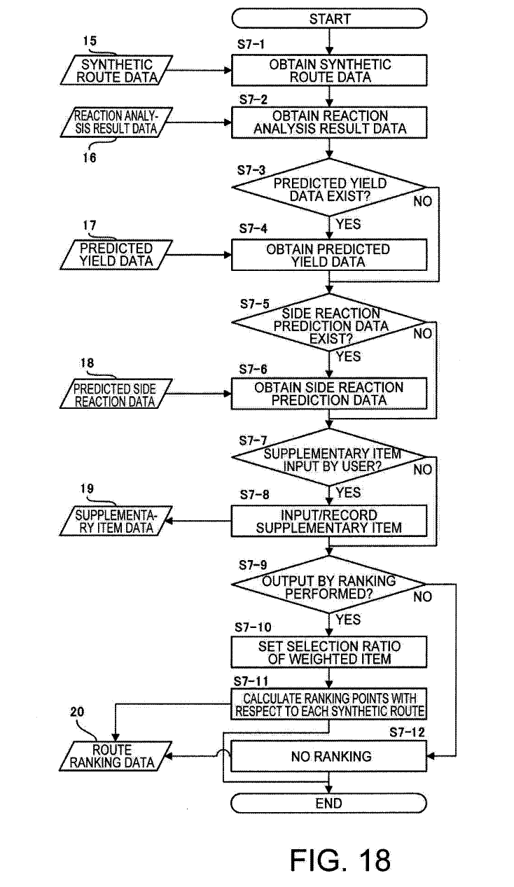

FIG. 18 is a process flowchart of the synthetic route ranking function in the synthetic route ranking unit of the arithmetic processing device of the synthetic route evaluation system according to the embodiment.

The synthetic route ranking unit 11 of the arithmetic processing device 3 reads and obtains synthetic route data 15 from the first storage device 4 at step S7-1. Thereafter, reaction analysis result data 16 is read and obtained from the first storage device 4 at step S7-2.

At step S7-3, the synthetic route ranking unit 11 accesses the first storage device 4 and searches for the presence or absence of predicted yield data 17. If predicted yield data 17 exists, the predicted yield data 17 is read and obtained from the first storage device 4 at step S7-4.

Furthermore, if it is understood that the predicted yield data 17 does not exist at step S7-3 or if the predicted yield data 17 has been obtained at step S7-4, the process proceeds to step S7-5, at which the first storage device 4 is accessed, and the presence or absence of predicted side reaction data 18 is searched.

If the predicted side reaction data 18 exists, the predicted side reaction data 18 is read and obtained from the first storage device 4 at step S7-6.

Furthermore, if it is understood that the predicted side reaction data 18 does not exist at step S7-5 or if the predicted side reaction data 18 has been obtained at step S7-6, the process proceeds to step S7-7, at which the first storage device 4 is accessed, and the presence or absence of supplementary item data 19 is searched.

If the supplementary item data 19 exists, the supplementary item data 19 is read and obtained from the first storage device 4 at step S7-8.

If it is understood that the supplementary item data 19 does not exist at step S7-7 or if the supplementary item data 19 has been obtained at step S7-8, the process proceeds to step S7-9, at which a question of whether the output by ranking is required is displayed via the output device 6 in order to ask a user about determination whether the output by ranking is performed, and the input, which is performed by the user via the input device 2, of a signal about whether the output by ranking is required is awaited. Of course, at the steps previous to step S7-1, a question about whether the output by ranking is required may be pre-input via the input device 2 of the synthetic route evaluation system 1 in the form of some data, and data relative to whether the output by ranking is required may be automatically read, and it may be determined whether the output by ranking is required at step S7-9.

If the synthetic route ranking unit 11 receives a signal (information) to perform the output in some form at step S7-9, the selection ratio of a priority item about which one of the reaction analysis result data 16, the predicted yield data 17, the predicted side reaction data 18, and the supplementary item data 19 is weighted (i.e., is highly valued) is displayed via the output device 6 so as to be arbitrarily input via the input device 2 (step S7-10). Thereafter, points for ranking are calculated including the selection ratio of weight input by the user via the input device 2 at step S7-11. The selection ratio of the weight can, of course, be freely selected in the predicted yield data 17, the predicted side reaction data 18, and the supplementary item data 19 other than the reaction analysis result data 16, and hence there is a case in which that is not selected. In that case, the synthetic route ranking unit 11 is not required to display the item at step S7-10.

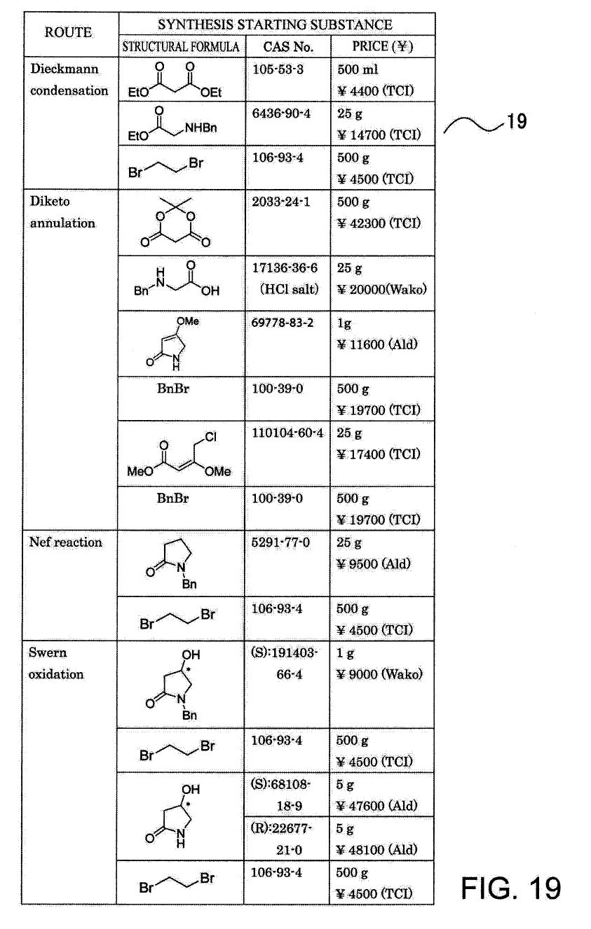

The supplementary item data 19 is appropriately added by the user, and is pre-stored in the first storage device 4. This makes it possible for the user to add a user's own evaluation item for an elementary reaction route and to reflect it in the ranking. The supplementary item data is input in the form of a table in which items are arranged in a row whereas each route is arranged in the column. Herein, as one example of the supplementary item data 19, FIG. 19 shows a data example in which the price of a synthesis starting substance is given to each route of 5-Benzyl-5-aza-spiro[2.4] heptane[4.7]-dione that is a product 31 as a supplementary item. There is a case in which the number of the supplementary item is two or more, and, in this case, each item can be individually weighted.

FIG. 19 is a conceptual diagram that shows data relative to supplementary items added at the processing of the synthetic route ranking function in the synthetic route ranking unit of the arithmetic processing device of the synthetic route evaluation system according to the embodiment.

Finally, at step S7-11, obtained values are changed into points for each reaction route by use of Ranking Formula (2) shown below. Herein, “Ps” designates ranking points, “B” designates a highest point (bias value), “n” designates the number of evaluation items including the supplementary item, “W” designates the entire weight expressed by Formula (3), “Wi” designates the weight (selection ratio) of an evaluation item, “S” designates the number of synthetic routes, and “Ri” designates the ranking in the evaluation items, which is expressed by natural number 1 or greater and in which 1 is the highest in the ranking. Of course, Formulas (2) and (3) are examples, and, without being limited to Formulas (2) and (3), other formulas may be employed as long as these formulas can perform ranking including the reaction analysis result data 16, the predicted yield data 17, the predicted side reaction data 18, and the supplementary item data 19. The ranking formula may be pre-installed in the synthetic route ranking unit 11 including the weight function, or may be pre-stored in the first storage device 4 or the second storage device 5, so that the synthetic route ranking unit 11 reads the ranking formula, and a calculation is performed in such a manner as to substitute the pieces of data 16 to 19 thereinto.

[Formula 2]

[Formula 3]

Ranking among the evaluation items is performed such that low reaction heat (ΔE) in total is ranked as being high in the reaction analysis data, and a high predicted yield is ranked as being high in the predicted yield data, and a side reaction small in number is ranked as being high in the side reaction prediction. However, these can be changed into desired order according to the setting by the user. The supplementary item of the user is ranked by the setting arranged by the user. Data in which ranking points have been calculated is stored in the form of a table as route ranking data. Herein, as one example thereof, route ranking data is shown in Table in which a product 31 is 5-Benzyl-5-aza-spiro[2.4]heptane[4.7]-dione. In Table 6, the product 31 is shown, and factors based on which ranking is performed and ranking points are orderly shown according to the kind of each reaction route, such as a Dieckmann condensation reaction. However, reactants 32 may be shown instead of the kind of each reaction route.

[Table 6]

If processing in which the output by ranking is not performed is selected at step S7-9, the process proceeds to step S7-12, at which the synthetic route ranking unit 11 does not perform a ranking display. However, the synthetic route data 15, the reaction analysis result data 16, the predicted yield data 17, and the predicted side reaction data 18, each of which has been selected until then, and the supplementary item data 19, which will be not-ranked data if selected, are included in the route ranking data 20 to be shown as user's evaluation and judging material. Thereafter, the ranking operation is ended.

As a data set, the route ranking data 20 is set with data relative to activation energy and/or reaction heat included in the selected reaction analysis result data 16 along with reactants and/or products included in the synthetic route data 15, or is set with the predicted yield data 17, or is set with the predicted side reaction data 18.

If ranking points are calculated at step S7-11, the synthetic route ranking unit 11 creates route ranking data 20. This data is arranged as a data set in which ranking points are included in addition to data relative to activation energy and/or reaction heat included in the selected reaction analysis result data 16 along with reactants and/or products included in the above-mentioned synthetic route data 15, or in addition to the predicted yield data 17, or in addition to the predicted side reaction data 18.

In this embodiment, in the synthetic route ranking unit 11, the predicted yield data 17, the predicted side reaction data 18, the supplementary item data 19, etc., are selectively added to activation energy and/or reaction heat, and, based on the result, ranks can be shown according to a desired idea while performing weighting, and therefore synthetic routes can be evaluated from various viewpoints, and an optimal synthetic route can be extracted.

Additionally, structural optimization is performed by use of structure data relative to transition states, and, as a result, it is possible to optimize not only structure data relative to reactants and products but also structure data relative to transition states, and therefore a quantum chemical calculation can be performed with higher accuracy for the same calculation time, or can be performed for a shorter calculation time with the same accuracy.

The synthetic route evaluation system according to this embodiment has been described as above, and, on the assumption that the system of FIG. 1 is a general-purpose computer and that a program for operating this computer is run in the manner of flowcharts shown in FIG. 3, FIG. 4, FIG. 9, and FIG. 15 to FIG. 18, the above description can be regarded as a description of an embodiment of a synthetic route evaluation method for evaluating an optimal synthetic route while the computer executes each step, and, at the same time, as a description of an embodiment of a program for operating the computer.

### INDUSTRIAL APPLICABILITY

As described above, the invention according to claim 1 to claim 8 of the present invention can be used in the pharmaceutical field or the chemical field in which a new compound is synthetically produced widely and generally for new drug development or for agricultural chemical development.

### [FIG. 1]

2 Input device
4 First storage device
15 Synthetic route data
16 Reaction analysis result data
17 Predicted yield data
18 Predicted side reaction data
19 Supplementary item data
20 Route ranking data
3 Arithmetic processing device
7 Quantum chemistry calculation unit
8 Reaction mechanism analysis unit
9 Yield prediction unit
10 Side reaction prediction unit
11 Synthetic route ranking unit
5 Second storage device (data base)
25 Experimental data
26 Quantum chemistry calculation result data
27 Yield prediction formula data
6 Output device

### [FIG. 2]

16 Reaction analysis result data
2 Reaction analysis function
19a Route supplementary item data by user
15a, 15b Synthetic route group according to user idea or SRDS idea
1 Quantum chemistry calculation function
19 Supplementary item data
6 Synthetic route input/output function
15 Synthetic route data
26 Quantum chemistry calculation result data
5 Synthetic route ranking function
18 Predicted side reaction data
3 Yield prediction function
27 Yield prediction formula data
25 Experimental data
20 Route ranking data
20a Already-ranked synthetic route group
4 Side reaction prediction function
17 Predicted yield data
25a Outside experimental data

### [FIG. 3]

Start
S1 Synthetic route input/output function (input)
S2 Reaction analysis function
S3 Evaluation by yield added?
Yes
No
S4 Yield prediction function
S5 Evaluation by side reaction added?
Yes
No
S6 Side reaction prediction function
S7 Synthetic route ranking function
S8 Synthetic route input/output function (output)
End

### [FIG. 4]

Start
S1-1 Input or output of route?
Output
Input
15 Synthetic route data
S1-8 Obtain synthetic route data
20 Route ranking data
S1-9 Obtain ranking data
6 Output device
S1-10 Output already-ranked synthetic route
S1-2 Input method of user synthetic route data?
Direct input
S1-3 Input synthetic route data
15a User synthetic route data
Input from SRDS
S1-4 Connect to SRDS
S1-5 Receive synthetic route data
15b SRDS synthetic route data
S1-6 Resolve synthetic route into elementary reactions
15 Synthetic route data
S1-7 Output synthetic route (elementary reaction)
End

### [FIG. 9]

Start
15 Synthetic route data
S2-1 Obtain synthetic route data
S2-2 Is there an elementary reaction route that has not yet been evaluated?
Yes
No
S2-3 Create calculation input data (transition state/product/reactant)
S2-4 Output calculation input data and input to quantum chemistry calculation function
28 Calculation input data
S2-5 Quantum chemistry calculation function
26 Quantum chemistry calculation result data
S2-6 Obtain calculation result data
S2-7 Transition state exist?
Yes
No
S2-8 Calculate activation energy value and reaction heat value
S2-9 Record that a reaction does not progress
S2-10 Output reaction analysis result
16 Reaction analysis result data
End

### [FIG. 15]

Start
28 Calculation input data
T1 Input calculation type/coordinates/level
26a Quantum chemistry calculation result data (similar structure)
T2 Similar optimized structure exist?
Yes
No
T3 Automatically input optimized structure
T4 Recognize difference structure (substituent)
T5 Give substituent
T6 Fix non-structurally-optimized part
T7 Perform partial structural optimization calculation
T8 Release non-structurally-optimized part from being fixed
T9 Determine calculation type
Structural optimization
Transition state calculation
T10 Perform structural optimization calculation
26 Quantum chemistry calculation result data
T11 Partial structural optimization performed?
Yes
No
T12 Determine transition state search method
Minimum energy path method, Contour map method
T13 Perform minimum energy path calculation
Saddle method
T14 Perform saddle calculation
T15 Contour map method?
Yes
No
T16 Perform minimum energy path calculation (second time)
T17 Create transition state similar structure (calculation coordinates)
T18 Perform structural optimization calculation to transition state
T19 Output calculation result
End

### [FIG. 16]

Start
15 Synthetic route data
S4-1 Obtain synthetic route data
S4-2 Is there an elementary reaction route that has not yet been evaluated?
Yes
No
S4-3 Yield prediction formula of reaction exist?
Yes
No
16 Reaction analysis result data
S4-4 Obtain calculation result data
25 Experimental data
S4-5 Experimental data exist?
Yes
No
25 Experimental data
S4-6 Input outside experimental data
S4-7 Select predictive variable
S4-8 Perform multivariate analysis
S4-9 Construct yield prediction formula
27 Yield prediction formula data
17 Predicted yield data
S4-10 Calculate predicted yield
End

### [FIG. 17]

Start
15 Synthetic route data
S6-1 Obtain synthetic route data
S6-2 Is there an elementary reaction route that has not yet been evaluated?
Yes
No
26 Quantum chemistry calculation result data
S6-3 Search for similar reaction with respect to product/reactant
S6-4 Similar reaction exist?
Yes
No
S6-5 Construct side reaction based on similar reaction
S6-6 Fulfill reaction analysis function
S6-7 Evaluation by yield added?
Yes
No
S6-8 Fulfill yield prediction function
S6-9 Determine that there is not a side reaction
S6-10 Output predicted side reaction
18 Predicted side reaction data
End

### [FIG. 18]

Start
15 Synthetic route data
S7-1 Obtain synthetic route data
16 Reaction analysis result data
S7-2 Obtain reaction analysis result data
S7-3 Predicted yield data exist?
Yes
No
17 Predicted yield data
S7-4 Obtain predicted yield data
S7-5 Side reaction prediction data exist?
Yes
No
18 Predicted side reaction data
S7-6 Obtain side reaction prediction data
S7-7 Supplementary item input by user?
Yes
No
19 Supplementary item data
S7-8 Input/record supplementary item
S7-9 Output by ranking performed?
Yes
No
S7-10 Set selection ratio of weighted item
S7-11 Calculate ranking points with respect to each synthetic route
20 Route ranking data
S7-12 No ranking
End

### [FIG. 19]

Route
Synthesis starting substance
Structural formula
Price (¥)

1. A synthetic route evaluation system comprising:
in order to extract an optimal synthetic route from a plurality of synthetic routes for a target compound to be synthetically produced,
an arithmetic processing means including a quantum chemistry calculation unit, a reaction mechanism analysis unit, and a synthetic route ranking unit; and
a storage means for storing data (hereinafter, referred to as synthetic route data relative to the synthetic routes;
wherein the synthetic route data is composed of structure data pairs the number of which is equal to the number of precursors from which the target compound can be synthetically produced,
wherein the structure data pairs are formed by correlating structure data relative to the target compound and structure data relative to the plurality of starting compounds with each other;
wherein the quantum chemistry calculation unit executes:
a step of reading the synthetic route data from the storage means, then performing a calculation in such a manner as to substitute the structure data relative to the starting compounds and the target compound into a structural optimization function, and obtaining structure data relative to the starting compounds structurally optimized and structure data relative to the target compound structurally optimized; and
a step of performing a calculation in such a manner as to substitute the structure data relative to the starting compounds structurally optimized and the structure data relative to the target compound structurally optimized into a synthetic-route transition state search function, and obtaining data relative to the presence or absence of a transition state in the synthetic routes and structure data (26) relative to the transition state under the condition of the presence of the transition state;
wherein the reaction mechanism analysis unit executes a step of setting data relative to whether a transition state is present or absent in the synthetic routes as a key from the storage means, and, if a transition state is present, performing a calculation in such a manner as to substitute structure data relative to the transition state into an activation energy calculation function, and obtaining activation energy and/or reaction heat in the transition state; and
wherein the synthetic route ranking unit executes a step of setting the activation energy and/or the reaction heat calculated while being correlated with the plurality of starting compounds as a key, and creating a data set in which the activation energy and/or the reaction heat are arranged in desired order along with the starting compounds and/or the target compound.

2. The synthetic route evaluation system according to claim 1,
wherein the quantum chemistry calculation unit executes a step of performing a calculation in such a manner as to substitute the structure data relative to the transition state into the structural optimization function and obtaining structure data relative to a transition state structurally optimized, and
wherein the reaction mechanism analysis unit performs a calculation in such a manner as to substitute the structure data relative to a transition state structurally optimized into the activation energy calculation function.

3. The synthetic route evaluation system according to claim 1,
wherein the arithmetic processing means includes a yield prediction unit,
wherein the yield prediction unit executes a step of, if there is a yield prediction formula pre-stored in the storage means, reading the yield prediction formula, then performing a calculation in such a manner as to substitute the structure data pairs of the synthetic route data into the yield prediction formula, and obtaining a predicted yield of each starting compound, or executes a step of, if there is not a yield prediction formula pre-stored in the storage means, reading experimental data relative to a reaction similar to a reaction caused to synthetically produce a target compound from the starting compounds stored in the storage means, then analyzing the yield prediction formula by use of a result of the experimental data, then performing a calculation in such a manner as to substitute the structure data pairs of the synthetic route data into the analyzed yield prediction formula, and obtaining a predicted yield of the starting compound, and
wherein the synthetic route ranking unit executes a step of creating a data set in which activation energy and/or reaction heat calculated in correlation with the plurality of starting compounds is arranged in desired order along with the starting compounds and/or the target compound while setting the activation energy and/or the reaction heat as a key or setting the predicted yield as a key.

4. The synthetic route evaluation system according to claim 3, wherein the arithmetic processing means includes a side reaction prediction unit,
wherein the side reaction prediction unit executes a step of searching for data relative to a similar reaction pre-stored in the storage means while setting the target compound and the starting compounds as a key, and defining and constructing a reaction similar to a synthetic route relative to a combination of the target compound and the starting compounds as a side reaction, and
wherein the synthetic route ranking unit executes a step of creating a data set in which activation energy and/or reaction heat calculated in correlation with the plurality of starting compounds or the predicted yield or the number of the side reactions is set as a key and is arranged in desired order along with the starting compounds and/or the target compound.

5. The synthetic route evaluation system according to claim 4,
wherein the arithmetic processing means includes a side reaction prediction unit,
wherein the side reaction prediction unit executes a step of searching for data relative to a similar reaction pre-stored in the storage means while setting the target compound and the starting compounds as a key, and defining and constructing a reaction similar to a synthetic route relative to a combination of the target compound and the starting compounds as a side reaction,
wherein the yield prediction unit executes a step of obtaining a predicted yield with respect to the target compound and the starting compounds in the constructed side reaction, and
wherein the synthetic route ranking unit a step of creating a data set in which activation energy and/or reaction heat calculated in correlation with the plurality of starting compounds, or the predicted yield, or the number of the side reactions, or the predicted yield of the side reaction is set as a key and is arranged in desired order along with the starting compounds and/or the target compound.

6. The synthetic route evaluation system according to claim 1 characterized by further comprising an output means for outputting the data set created by the synthetic route ranking unit.

7. A synthetic route evaluation method for, in order to extract an optimal synthetic route from a plurality of synthetic routes for a target compound to be synthetically produced while a computer performs each step, analyzing data (hereinafter, referred to as synthetic route data) relative to the synthetic routes, transition states halfway along the synthetic routes, and activation energy relative to the transition states, and evaluating the optimal synthetic route, the synthetic route evaluation method comprising:
a first quantum chemical calculation step of performing a calculation in such a manner as to substitute structure data relative to the target compound included in the synthetic route data and structure data relative to a plurality of starting compounds from which the target compound can be synthetically produced into a structure optimizing function, and obtaining structure data relative to the starting compounds structurally optimized and structure data relative to the target compound structurally optimized;
a second quantum chemical calculation step of performing a calculation in such a manner as to substitute the structure data relative to the starting compounds structurally optimized and the structure data relative to the target compound structurally optimized into a synthetic-route transition state search function, and obtaining data relative to the presence or absence of a transition state in the synthetic routes and structure data relative to the transition state under the condition of the presence of the transition state;
a reaction analysis step of setting data relative to whether a transition state is present or absent in the synthetic routes as a key, and, if a transition state is present, performing a calculation in such a manner as to substitute structure data relative to the transition state into an activation energy calculation function, and obtaining activation energy and/or reaction heat in the transition state; and
a synthetic route ranking step of setting the activation energy and/or the reaction heat calculated in correlation with the plurality of starting compounds as a key and creating a data set in which the activation energy and/or the reaction heat is arranged in desired order along with the starting compounds and/or the target compound.

8. A synthetic route evaluation program for, in order to extract an optimal synthetic route from a plurality of synthetic routes for a target compound to be synthetically produced by use of a computer, analyzing data (hereinafter, referred to as synthetic route data) relative to the synthetic routes, transition states halfway along the synthetic routes, and activation energy relative to the transition states, and evaluating the optimal synthetic route, the synthetic route evaluation program allowing the computer to perform:
a first quantum chemical calculation step of performing a calculation in such a manner as to substitute structure data relative to the target compound included in the synthetic route data and structure data relative to a plurality of starting compounds from which the target compound can be synthetically produced into a structure optimizing function, and obtaining structure data relative to the starting compounds structurally optimized and structure data relative to the target compound structurally optimized;
a second quantum chemical calculation step of performing a calculation in such a manner as to substitute the structure data relative to the starting compounds structurally optimized and the structure data relative to the target compound structurally optimized into a synthetic-route transition state search function, and obtaining data relative to the presence or absence of a transition state in the synthetic routes and structure data relative to the transition state under the condition of the presence of the transition state;
a reaction analysis step of setting data relative to whether a transition state is present or absent in the synthetic routes as a key, and, if a transition state is present, performing a calculation in such a manner as to substitute structure data relative to the transition state into an activation energy calculation function, and obtaining activation energy and/or reaction heat in the transition state; and
a synthetic route ranking step of setting the activation energy and/or the reaction heat calculated in correlation with the plurality of starting compounds as a key, and creating a data set in which the activation energy and/or the reaction heat is arranged in desired order along with the starting compounds and/or the target compound.

9. The synthetic route evaluation system according to claim 2, wherein the arithmetic processing means includes a yield prediction unit,
wherein the yield prediction unit executes a step of, if there is a yield prediction formula pre-stored in the storage means, reading the yield prediction formula, then performing a calculation in such a manner as to substitute the structure data pairs of the synthetic route data into the yield prediction formula, and obtaining a predicted yield of each starting compound, or executes a step of, if there is not a yield prediction formula pre-stored in the storage means, reading experimental data relative to a reaction similar to a reaction caused to synthetically produce a target compound from the starting compounds stored in the storage means, then analyzing the yield prediction formula by use of a result of the experimental data, then performing a calculation in such a manner as to substitute the structure data pairs of the synthetic route data into the analyzed yield prediction formula, and obtaining a predicted yield of the starting compound, and
wherein the synthetic route ranking unit executes a step of creating a data set in which activation energy and/or reaction heat calculated in correlation with the plurality of starting compounds is arranged in desired order along with the starting compounds and/or the target compound while setting the activation energy and/or the reaction heat as a key or setting the predicted yield as a key.

10. The synthetic route evaluation system according to claim 2 further comprising an output means for outputting the data set created by the synthetic route ranking unit.

11. The synthetic route evaluation system according to claim 3 further comprising an output means for outputting the data set created by the synthetic route ranking unit.

12. The synthetic route evaluation system according to claim 4 further comprising an output means for outputting the data set created by the synthetic route ranking unit.

13. The synthetic route evaluation system according to claim 5 further comprising an output means for outputting the data set created by the synthetic route ranking unit.
